(19) United States
(12) Patent Application Publication
(10) Pub. No.: US 2010/0020660 A1
(43) Pub. Date: Jan. 28, 2010

(54) INFORMATION RECORDING APPARATUS AND METHOD, COMPUTER PROGRAM, AND RECORDING MEDIUM

(75) Inventors: Hiroyuki Uchino, Saitama (JP); Shogo Miyanabe, Saitama (JP); Yoshio Sasaki, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/526,689

(22) PCT Filed: Feb. 13, 2007
(86) PCT No.: PCT/JP2007/052506

§ 371 Date: Sep. 9, 2009

(51) Int. Cl. G11B 7/00

(52) U.S. Cl. 369/53.2; G9B/7

(57) ABSTRACT

An information recording apparatus (1) comprises a recording means (11) for recording a data pattern on a recording medium (100), a reading means (11) for reading the data pattern to acquire a read signal, adding means (23, 24) for adding an offset signal to the read signal to acquire an offset-added signal, a measurement means (19) for measuring the jitter of the offset-added signal, and an adjustment means (21) for adjusting a recording condition so that the jitter satisfies a desired condition

### TECHNICAL FIELD

The present invention relates to an information recording apparatus for and method of recording a data pattern onto a recording medium, a computer program which makes a computer as such an information recording apparatus, and the recording medium.

### BACKGROUND ART

Optical discs such as a DVD and a Blu-ray disc have been rapidly spread. In such optical discs, a data pattern is recorded onto a recording surface by irradiating the recording surface with a laser beam. Thus, in order to perform optimum recording, it is necessary to perform a recording compensation operation, which is an operation of making the strategy of the laser beam (i.e. the shape of a recording pulse) be appropriate. A patent document 1 discloses one example of the recording compensation operation. Specifically, in a technology disclosed in the patent document 1, an edge shift amount, an edge level, a read signal obtained by reading (i.e. reproducing) the data pattern, and its binary result or the like are recorded into an external memory, and they are subsequently analyzed by using analysis software in a host PC or the like, to thereby perform the recording compensation operation.
Patent document 1: Japanese Patent Application Laid Open No. 2006-120208

### DISCLOSURE OF INVENTION

### Subject to be Solved by the Invention

However, in the so-called conventional recording compensation operation described in the patent document 1 or the like, the following technical problem may occur. For example, the asymmetry of the read signal on which the recording compensation is performed transits to 0%, regardless of the asymmetry before the recording compensation. On the other hand, if another recording property such as jitter is optimum, the asymmetry is not always 0%. In other words, although another recoding property such as jitter is optimum when the asymmetry has a value other than 0%, the asymmetry after the recoding compensation uniformly transits to 0%.

In view of the aforementioned problems, it is therefore an object of the present invention to provide, for example, an information recording apparatus and method in which the asymmetry of the read signal after the recording compensation can be set to a desired value, and a computer program and a recording medium.

### Means for Solving the Subject

The above object of the present invention can be achieved by an information recording apparatus provided with: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device.

The above object of the present invention can be also achieved by an information recording method in an information recording apparatus provided with a recording device for recording a data pattern onto a recording medium, the information recording method provided with: a reading process of reading the data pattern recorded on the recording medium, thereby obtaining a read signal; an adding process of adding an offset signal to the read signal, thereby obtaining an offset-added signal; a measuring process of measuring jitter of the offset-added signal; a detecting process of detecting a data pattern of the read signal; and an adjusting process of adjusting a recording condition of the recording device such that the jitter measured in the measuring process satisfies a desired condition, with reference to the data pattern detected in the detecting process.

The above object of the present invention can be also achieved by a computer program for recording control and for controlling a computer provided in an information recording apparatus provided with: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device, the computer program making the computer function as at least one portion of the recording device, the reading device, the adding device, the measuring device, the detecting device, and the adjusting device.

The above object of the present invention can be also achieved by a recording medium provided with a recording condition recording area to record therein a recording condition adjusted by an information recording apparatus provided with: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device.

These operation and other advantages of the present invention will become more apparent from the embodiments explained below.

### BRIEF DESCRIPTION OF DRAWINGS

FIG. 1 is a block diagram conceptually showing the basic structure of an information recording apparatus in a first example.

FIG. 2 is a flowchart conceptually showing a flow of operations in a first operation example of the information recording apparatus in the first example.

FIG. 3 is a waveform diagram conceptually showing an operation of measuring jitter by an averaging circuit on a high-frequency emphasized read sample value series.

FIG. 4 is a block diagram conceptually showing the basic structure of the averaging circuit.

FIG. 5 is a graph conceptually showing the states of shift jitter components in respective data patterns and a shift jitter component as a whole before recording compensation and the states of shift jitter components in respective data patterns and a shift jitter component as a whole after the recording compensation.

FIG. 6 is a graph conceptually showing a relation among the jitter as a whole, a random Jitter component, and the shift jitter component.

FIG. 7 are graphs conceptually showing aspects of reduction in the shift jitter component if the random jitter component is 7%.

FIG. 8 are graphs conceptually showing aspects of reduction in the shift jitter component if the random jitter component is 5%.

FIG. 9 are graphs conceptually showing aspects of reduction in the shift jitter component if the random jitter component is 10%.

FIG. 10 are other graphs conceptually showing the relation among the jitter as a whole, the random jitter component, and the shift jitter component if a ratio of the random jitter component to a total jitter is fixed.

FIG. 11 is a timing chart conceptually showing a first aspect of a recording strategy adjustment operation.

FIG. 12 is a timing chart conceptually showing a second aspect of the recording strategy adjustment operation.

FIG. 13 is a timing chart conceptually showing a third aspect of the recording strategy adjustment operation.

FIG. 14 are graphs conceptually showing a relation of a recording power vs. the total jitter and a relation of a β value vs. the total jitter before and after the recording compensation.

FIG. 15 are waveform diagrams conceptually showing a read signal before and after the recording compensation.

FIG. 16 are graphs conceptually showing the detection probability of a front edge of the shortest data pattern included in the read signal outputted from a limit equalizer and the detection probability of a front edge of the shortest data pattern included in the read signal outputted from a pre-equalizerpre-equalizer.

FIG. 17 are graphs conceptually showing the detection probability of a rear edge of the shortest data pattern included in the read signal outputted from the limit equalizer and the detection probability of a rear edge of the shortest data pattern included in the read signal outputted from the pre-equalizerpre-equalizer.

FIG. 18 is a waveform diagram conceptually showing a relation between the read signal and asymmetry before and after the recording compensation.

FIG. 19 is a flowchart conceptually showing a flow of operations in a second operation example of the information recording apparatus in the first example.

FIG. 20 is a block diagram conceptually showing the basic structure of an information recording apparatus in a second example.

FIG. 21 is a block diagram conceptually showing the basic structure of an information recording apparatus in a third example.

FIG. 22 is a block diagram conceptually showing a relation between the basic structure of a reference level detection circuit and an adder provided for the information recording apparatus in the third example.

FIG. 23 is a waveform diagram conceptually showing a partial β value.

FIG. 24 is a waveform diagram conceptually showing an a value.

FIG. 25 is a flowchart conceptually showing a flow of operations in a first example operation of the information recording apparatus in the third example.

FIG. 26 is a graph conceptually showing the states of the shift jitter components in the respective data patterns and the shift jitter component as a whole before the recording compensation and the states of shift jitter components in respective data patterns and a shift jitter component as a whole after the recording compensation, in association with the asymmetry.

FIG. 27 are graphs conceptually showing a relation between the asymmetry and the jitter before and after the recording compensation.

FIG. 28 are graphs conceptually showing a relation between the asymmetry and the jitter before and after the recording compensation in a comparative example.

FIG. 29 is a waveform diagram conceptually showing a relation between the read signal and the asymmetry before and after the recording compensation.

FIG. 30 is a graph conceptually showing a relation between the asymmetry and the jitter before and after the recording compensation.

FIG. 31 is a graph conceptually showing a relation between the asymmetry and the jitter before and after the recording compensation.

FIG. 32 are waveform diagrams conceptually showing an operation of setting a reference level on the waveform of the read signal.

FIG. 33 is a flowchart conceptually showing a flow of operations in a second operation example of the information recording apparatus in the third example.

FIG. 34 is a flowchart conceptually showing a flow of operations in a third operation example of the information recording apparatus in the third example.

FIG. 35 is a block diagram conceptually showing the basic structure of an information recording apparatus in a fourth example.

FIG. 36 is a data structure diagram showing one example of the data structure when recording a result of the recording compensation operation onto the Blu-ray Disc, which is one specific example of the optical disc.

FIG. 37 is a data structure diagram showing one example of the data structure when recording a result of the recording compensation operation onto the Blu-ray Disc, which is one specific example of the optical disc.

FIG. 38 is a data structure diagram showing one example of the data structure when recording a result of the recording compensation operation onto the Blu-ray Disc, which is one specific example of the optical disc.

FIG. 39 is a data structure diagram showing one example of the data structure when recording a result of the recording compensation operation onto the Blu-ray Disc, which is one specific example of the optical disc.

FIG. 40 is a data structure diagram showing one example of a data structure when recording a result of the recording compensation operation onto a DVD, which is one specific example of the optical disc.

FIG. 41 is a data structure diagram showing one example of the data structure when recording a result of the recording compensation operation onto the DVD, which is one specific example of the optical disc.

FIG. 42 is a data structure diagram showing one example of the data structure when recording a result of the recording compensation operation onto the DVD, which is one specific example of the optical disc.

FIG. 43 is a data structure diagram showing one example of the data structure when recording a result of the recording compensation operation onto the DVD, which is one specific example of the optical disc.

### DESCRIPTION OF REFERENCE CODES

1, 2, 3, 4 information recording apparatus
10 spindle motor
11 pickup
12 HPF
13 A/D converter
14 pre-equalizerpre-equalizer
15 limit equalizer
16 binary circuit
17 decoding circuit
18 delay circuit
19 averaging circuit
20 pattern judgment circuit
21 recording strategy setting circuit
22 interpolation filter
23 adder
24 reference level detection device

### BEST MODE FOR CARRYING OUT THE INVENTION

Hereinafter, as the best mode for carrying out the present invention, an explanation will be given on embodiments of the information recording apparatus and method, and the computer program of the present invention.

### Embodiment of Information Recording Apparatus

An embodiment of the information recording apparatus of the present invention is an information recording apparatus provided with: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device.

According to the embodiment of the information recording apparatus of the present invention, by the operation of the recording device, the data pattern according to the data to be recorded is recorded onto the information recording medium.

Here, on the information recording apparatus in the embodiment, a recording compensation operation explained below is performed in parallel with the operation of recording the data pattern performed by the recording device.

Firstly, by the operation of the reading device, the recorded data pattern is read. As a result, the read signal is obtained. Then, by the operation of the adding device, the offset signal is added to the read signal. As a result, the offset-added signal is obtained. Incidentally, the offset signal is preferably set such that the asymmetry of the read signal after the recording compensation can be set to the desired value, as occasion demands, as detailed later.

Then, by the operation of the measuring device, the jitter of the offset-added signal is measured. In other words, in the embodiment, instead of measuring the jitter by directly using the read signal obtained by reading the data pattern from the recording medium, the jitter is measured by using the offset-added signal obtained by adding the offset signal to the read signal.

Moreover, by the operation of the detecting device, the data pattern of the read signal is detected. More specifically, it is detected which run length the data pattern of the read signal has.

Then, by the operation of the adjusting device, the recording condition (specifically, for example, recording strategy) of the recording device is adjusted such that the measured jitter satisfies the desired condition.

By this, the jitter of the read signal obtained by reading the data pattern recorded after the adjustment of the recording condition satisfies the desired condition. Therefore, it is possible to improve the reading quality of the read signal (in other words, recording quality or reproduction quality).

In particular, according to the embodiment, in accordance with the addition of the offset signal, it is possible to set the asymmetry of the read signal after the recording compensation to the desired value, regardless of the state of the asymmetry before the recording compensation, as detailed later with reference to the drawing.

In one aspect of the embodiment of the information recording apparatus of the present invention, the adding device adds the offset signal such that a reference level of the read signal is set to a level which indicates a predetermined rate of an amplitude of the read signal.

According to this aspect, in accordance with the addition of the offset signal, it is possible to set the asymmetry of the read signal after the recording compensation to the desired value, regardless of the state of the asymmetry before the recording compensation.

In another aspect of the embodiment of the information recording apparatus of the present invention, the adding device adds the offset signal such that asymmetry of the read signal is set to a desired value.

According to this aspect, in accordance with the addition of the offset signal, it is possible to set the asymmetry of the read signal after the recording compensation to the desired value, regardless of the state of the asymmetry before the recording compensation.

In another aspect of the embodiment of the information recording apparatus of the present invention, the adding device adds the offset signal corresponding to a difference between asymmetry of the read signal before the offset signal is added and the asymmetry desired to be realized by adding the offset signal.

According to this aspect, in accordance with the addition of the offset signal, it is possible to set the asymmetry of the read signal after the recording compensation to the desired value, regardless of the state of the asymmetry before the recording compensation.

In one aspect of the embodiment of the information recording apparatus of the present invention, the measuring device measures, as the jitter, a shift jitter component caused by a state of the recorded data pattern from among the jitter, and the adjusting device adjusts the recording condition such that the shift jitter component as the jitter satisfies the desired condition.

According to this aspect, not the random jitter component, which is hardly predicted or which cannot be predicted, but the shift Jitter component caused by the state of the data pattern which depends on the recording condition is measured. Therefore, by adjusting the recording condition, it is possible to preferably perform the recording compensation operation such that the shift jitter component satisfies the desired condition, relatively easily.

In an aspect of the information recording apparatus in which the recording condition is adjusted such that the shift jitter component satisfies the desired condition, as described above, the state in which the jitter satisfies the desired condition may be a state in which the shift jitter component is less than or equal to a first predetermined value.

By virtue of such construction, it is possible to preferably perform the recording compensation operation so as to reduce the shift jitter component.

In an aspect of the information recording apparatus in which the recording condition is adjusted such that the shift jitter component satisfies the desired condition, as described above, a state in which the jitter satisfies the desired condition may be a state in which a ratio of a random jitter component, which is caused by a noise from among the jitter, to the jitter is greater than or equal to a second predetermined value.

The jitter is indicated by the square root of a sum of the square of the random jitter component and the square of the shift jitter component. Thus, if the random jitter component is greater than the shift jitter component (i.e. if the ratio of the random jitter component to the jitter is relatively large), the jitter is hardly reduced even if the shift jitter component is reduced. Therefore, by virtue of such construction, it is possible to perform the recording compensation operation such that a jitter-reduction effect is preferably achieved by the adjustment of the recording condition. In other words, it is possible to preferably avoid the inefficient recording compensation operation in which the jitter-reduction effect is not preferably achieved by the adjustment of the recording condition.

In an aspect of the information recording apparatus in which the recording condition is adjusted such that the shift jitter component satisfies the desired condition, as described above, a state in which the jitter satisfies the desired condition is a state in which the shift jitter components in a plurality of respective data patterns with different run lengths may be substantially the same to each other.

By virtue of such construction, it is possible to match the shift jitter components in a plurality of types of respective data patterns (e.g. 10 types of data patterns with run lengths of 3T to 11T and 14T if the information recording medium is a DVD, and 7 types of data patterns with run lengths of 2T to 9T if the information recording medium is a Blu-ray Disc). In other words, instead of narrowing jitter distributions in the respective data patterns, it is possible to match the average values of the jitter distributions in the respective data patterns (i.e. the shift jitter components). By this, it is possible to perform the recording compensation operation which reduces the jitter, preferably and relatively easily.

In an aspect of the information recording apparatus in which the recording condition is adjusted such that the shift jitter component satisfies the desired condition, as described above, the measuring device may measure, as the shift Jitter component, an average value in each data pattern of sample values of the offset-added signal which is the closest to a zero level point.

By virtue of such construction, it is possible to measure the shift jitter component, preferably and relatively easily.

In an aspect of the information recording apparatus in which the recording condition is adjusted such that the shift jitter component satisfies the desired condition, as described above, the adjusting device may preferentially adjust the recording condition in recording the data pattern having the relatively large shift jitter component out of a plurality of type of the data patterns with different run lengths.

By virtue of such construction, it is possible to reduce the jitter more efficiently, in comparison to the construction that the recording condition in each data pattern is randomly adjusted.

In another aspect of the embodiment of the information recording apparatus of the present invention, the recording device applies a laser beam, thereby recording the data pattern, and the recording condition is at least one of an amplitude and a pulse width of the laser beam or a driving pulse for driving the laser beam.

By virtue of such construction, it is possible to preferably perform the recording compensation operation by adjusting the amplitude and the pulse width of the driving pulse or the laser beam.

In another aspect of the embodiment of the information recording apparatus of the present invention, it is further provided with an amplitude limit filtering device for limiting an amplitude level of the read signal by using a predetermined amplitude limit value, thereby obtaining an amplitude limit signal and for performing a high-frequency emphasis filtering process on the amplitude limit signal, thereby obtaining an equalization-corrected signal, the adding device adding the offset signal to the equalization-corrected signal, thereby obtaining the offset-added signal, the detecting device detecting the data pattern of the equalization-corrected signal.

According to this aspect, then, by the operation of the amplitude limit filtering device, the amplitude level of the read signal is limited. Specifically, in a signal component of the read signal whose amplitude level is greater than an upper limit of the amplitude limit value or whose amplitude level is less than a lower limit of the amplitude limit value, its amplitude level is limited to the upper limit or the lower limit of the amplitude limit value. On the other hands in a signal component of the read signal whose amplitude level is less than or equal to the upper limit of the amplitude limit value or whose amplitude level is greater than or equal to the lower limit of the amplitude limit value, its amplitude level is not limited. As described above, the read signal whose amplitude level is limited is referred to as the amplitude limit signal. Moreover, the amplitude limit filtering device performs the high-frequency emphasis filtering process on the amplitude limit signal. As a result, the equalization-corrected signal is obtained in which the shortest data pattern included in the read signal (e.g. the data pattern with a run length of 3T if the information recording medium is a DVD, and the data pattern with a run length of 2T if the information recording medium is a Blu-ray Disc) has an emphasized amplitude level. In other words, the amplitude limit filtering device performs the same operation as a so-called limit equalizer, on the read signal.

Thus, in any state of the asymmetry of the read signal, it is possible to preferably prevent such a disadvantage that the shortest data pattern included in the read signal does not cross a zero level. As a result, the shortest data pattern can be preferably detected. Thus, it is possible to preferably adjust the recording condition for recording the shortest data pattern. By this, the recording compensation operation can be preferably performed with reference to the read signal including the shortest data pattern. In other words, regardless of the state of the asymmetry in the read signal before the recording compensation, the recording compensation operation can be preferably performed.

In another aspect of the embodiment of the information recording apparatus of the present invention, the recording device records the recording condition adjusted by the adjusting device. In this case, the recording condition is preferably recorded in association with identification information for identifying the information recording apparatus.

According to this aspect, the identification information of the information recording apparatus and the recording condition are recorded on the recording medium. Thus, by reading the recording condition, which corresponds to the identification information of the information recording apparatus, from the recording medium and by using it as the recording condition of the recording device when the data pattern is recorded by the information recording apparatus, it is possible to receive the same various effects as those described above, in the recording operation performed on the recording medium, without going to the trouble of adjusting the recording condition.

Moreover, even if the recording condition is not recorded on the recording medium for the reason that that the recording medium is blank or the like, in the embodiment, in accordance with the addition of the offset signal, it is possible to set the asymmetry of the read signal after the recording compensation to the desired value, regardless of the state of the asymmetry before the recording compensation, as detailed later with reference to the drawings. Moreover, if the resulting recording condition is recorded on the recording medium in association with the identification information of the information recording apparatus, it is possible to receive the same various effects as those described above, in the recording performed on the recording medium, without going to the trouble of adjusting the recording condition next time the data pattern is recorded.

In other words, according to this aspect, without adjusting the recording condition by the adjusting device or with the recording condition adjusted at least once, it is possible to receive the same various effects as those described above, in the recording performed on the recording medium, without going to the trouble of adjusting the recording condition on the corresponding information recording apparatus.

### Embodiment of Information Recording Method

An embodiment of the information recording apparatus of the present invention is an information recording method in an information recording apparatus provided with a recording device for recording a data pattern onto a recording medium, the information recording method provided with: a reading process of reading the data pattern recorded on the recording medium, thereby obtaining a read signal; an adding process of adding an offset signal to the read signal, thereby obtaining an offset-added signal; a measuring process of measuring jitter of the offset-added signal; a detecting process of detecting a data pattern of the read signal; and an adjusting process of adjusting a recording condition of the recording device such that the jitter measured in the measuring process satisfies a desired condition, with reference to the data pattern detected in the detecting process.

According to the embodiment of the information recording method of the present invention, it is possible to receive the same various effects as those that can be received by the aforementioned embodiment of the information recording apparatus of the present invention.

Incidentally, in response to the various aspects in the aforementioned embodiment of the information recording apparatus of the present invention, the embodiment of the information recording method of the present invention can also adopt various aspects.

### Embodiment of Computer Program

An embodiment of the computer program of the present invention is a computer program for recording control and for controlling a computer provided in an information recording apparatus provided with: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device (i.e. the aforementioned embodiment of the information recording apparatus of the present invention (including its various aspects)), the computer program making the computer function as at least one portion of the recording device, the reading device, the adding device, the measuring device, the detecting device, and the adjusting device.

According to the embodiment of the computer program of the present invention, the aforementioned embodiment of the information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned embodiment of the information recording apparatus of the present invention, the embodiment of the computer program of the present invention can also adopt various aspects.

An embodiment of the computer program product of the present invention is a computer program product in a computer-readable medium for tangibly embodying a program of instructions executable by a computer provided in an information recording apparatus provided with: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device (i.e. the aforementioned embodiment of the information recording apparatus of the present invention (including its various aspects)), the computer program product making the computer function as at least one portion of the recording device, the reading device, the adding device, the measuring device, the detecting device, and the adjusting device.

According to the embodiment of the computer program product of the present invention, the aforementioned embodiment of the information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the information recording apparatus of the present invention.

Incidentally, in response to the various aspects in the aforementioned embodiment of the information recording apparatus of the present invention, the embodiment of the computer program product of the present invention can also employ various aspects.

### Embodiment of Recording Medium

An embodiment of the recording medium of the present invention is a recording medium provided with a recording condition recording area to record therein a recording condition adjusted by an information recording apparatus provided with: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device.

According to the embodiment of the recording medium of the present invention, the identification information of the information recording apparatus and the recording condition are recorded on the recording medium. Thus, by reading the recording condition, which corresponds to the identification information of the information recording apparatus, from the recording medium and by using it as the recording condition of the recording device when the data pattern is recorded by the information recording apparatus, it is possible to receive the same various effects as those described above, in the recording operation performed on the recording medium, without going to the trouble of adjusting the recording condition.

Moreover, even if the recording condition is not recorded on the recording medium for the reason that that the recording medium is blank or the like, in the embodiment, in accordance with the addition of the offset signal, it is possible to set the asymmetry of the read signal after the recording compensation to the desired value, regardless of the state of the asymmetry before the recording compensation, as detailed later with reference to the drawings. Moreover, if the resulting recording condition is recorded on the recording medium in association with the identification information of the information recording apparatus, it is possible to receive the same various effects as those described above, in the recording performed on the recording medium, without going to the trouble of adjusting the recording condition next time the data pattern is recorded.

In other words, according to the embodiment, without adjusting the recording condition by the adjusting device or with the recording condition adjusted at least once, it is possible to receive the same various effects as those described above, in the recording performed on the recording medium, without going to the trouble of adjusting the recording condition on the corresponding information recording apparatus.

Incidentally, the recording condition may be recorded in advance on the recording medium, or it may be recorded along with the recording operation, as occasion demands.

Incidentally, in response to the various aspects in the aforementioned embodiment of the information recording apparatus of the present invention, the embodiment of the recording medium of the present invention can also employ various aspects.

The operation and other advantages of the present invention will become more apparent from the examples explained below.

As explained above, according to the embodiment of the information recording apparatus of the present invention, it is provided with the recording device, the reading device, the adding device, the measuring device, the detecting device, and the adjusting device. According to the embodiment of the information recording method of the present invention, it is provided with the recording process, the reading process, the adding process, the measuring process, the detecting process, and the adjusting process. According to the embodiment of the computer program of the present invention, it makes a computer function as the embodiment of the information recording apparatus of the present invention. According to the embodiment of the recording medium of the present invention, it is provided with the recording condition recording area to record therein the recording condition adjusted by the aforementioned adjusting device. Therefore, it is possible to set the asymmetry of the read signal after the recording compensation to the desired value.

### Examples

Hereinafter, examples of the present invention will be described with reference to the drawings.

### (1) First Example

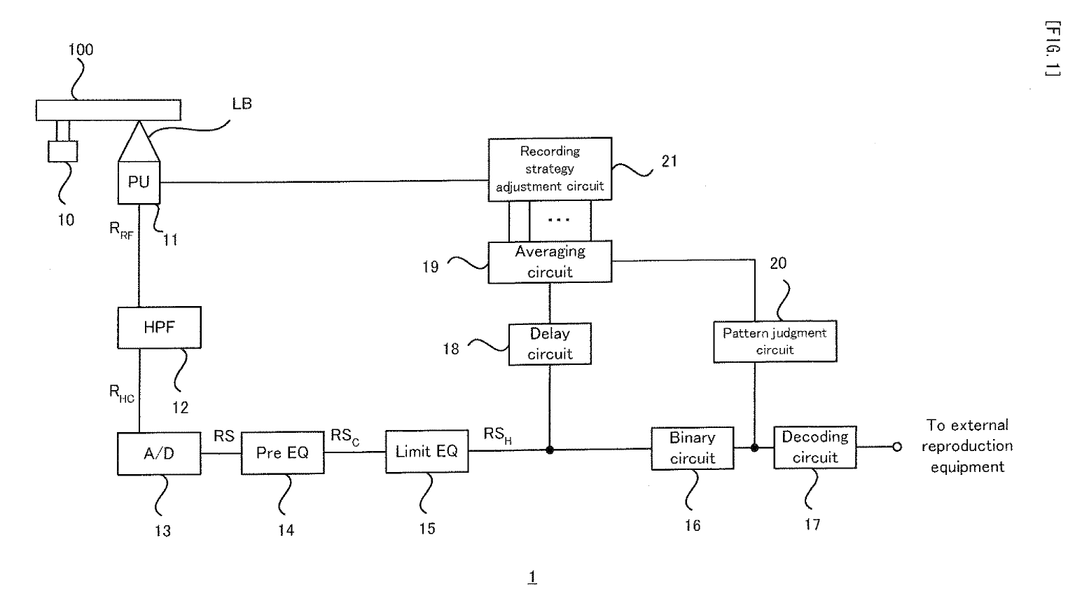

Firstly, with reference to FIG. 1 to FIG. 18, a first example of the information recording apparatus of the present invention will be explained.

(1-1) Basic Structure

Firstly, with reference to FIG. 1, the basic structure of an information recording apparatus in the first example will be described. FIG. 1 is a block diagram conceptually showing the basic structure of the information recording apparatus in the first example.

As shown in FIG. 1, an information recording apparatus 1 in the first example is provided with a spindle motor 10, a pickup (PU) 11, a HPF (High Pass Filter) 12, an A/D converter 13, a pre-equalizer 14, a limit equalizer 15, a binary circuit 16, a decoding circuit 17, a delay circuit 18, an averaging circuit 19, a pattern judgment circuit 20, and a recording strategy adjustment circuit 21.

The pickup 11 constitutes one specific example of the “recording device” and the “reading device” of the present invention. The pickup 11 photoelectrically converts reflected light when a laser beam LB is applied to a recording surface of an optical disc 100 rotated by the spindle motor 10, thereby generating a read signal R_{RF}. Moreover, the pickup 11 irradiates the recording surface of the optical disc 100 with the laser beam LB according to a recording strategy set on the recording strategy setting circuit 21, thereby recording a data pattern onto the optical disc 100.

The HPF 12 removes a low-frequency component of the read signal R_{RF} outputted from the pickup 11, and it outputs a resulting read signal R_{HC} to the A/D converter 13.

The A/D converter 13 samples the read signal R_{RF} in accordance with a sampling clock outputted from a PLL (Phased Lock Loop) not illustrated or the like, and it outputs a resulting read sample value series RS to the pre-equalizer 14.

The pre-equalizer 14 removes intersymbol interference which is based on transmission characteristics in an information reading system which is formed of the pickup 11 and the optical disc 100, and it outputs a resulting read sample value series RS_{C} to the limit equalizer 15

The limit equalizer 15 constitutes one specific example of the “amplitude limit filtering device” of the present invention. The limit equalizer 15 performs a high-frequency emphasis process on the read sample value series RS_{C} without increasing the intersymbol interference, and it outputs a resulting high-frequency emphasized read sample value series RS_{H} to each of the binary circuit 16 and the delay circuit 18. Incidentally, the operations of the limit equalizer 15 are the same as those of a conventional limit equalizer. Please refer to Patent publication No. 3459563 for the details.

The binary circuit 16 performs a binary process on the high-frequency emphasized read sample value series RS_{H}, and it outputs a resulting binary signal to each of the decoding circuit 17 and the pattern judgment circuit 19.

The decoding circuit 17 performs a decoding process or the like on the binary signal, and it outputs a resulting reproduction signal to external reproduction equipment such as a display and a speaker. As a result, data according to the data pattern recorded on the optical disc 100 (e.g. video data, audio data, and the like) is reproduced.

The delay circuit 18 applies a delay corresponding to a time required for the processes of the binary circuit 16 and the pattern judgment circuit 20 to the high-frequency emphasized read sample value series RS_{H}, and it outputs the high-frequency emphasized read sample value series RS_{H} to the averaging circuit 19. In other words, by the operations of the delay circuit 18, each sample value in the high-frequency emphasized read sample value series RS_{H} outputted from the limit equalizer 15 is inputted to the averaging circuit 19 in the same timing as the timing in which the data pattern judgment result of the sample value is inputted.

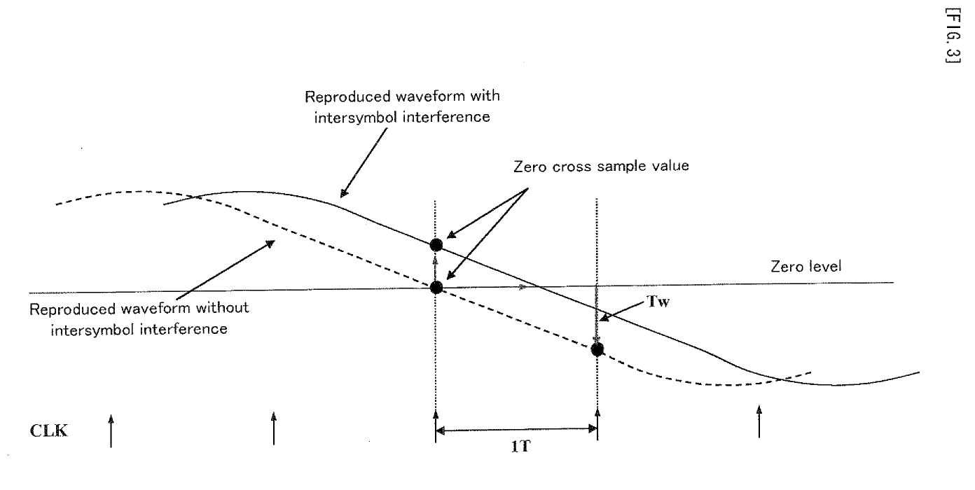

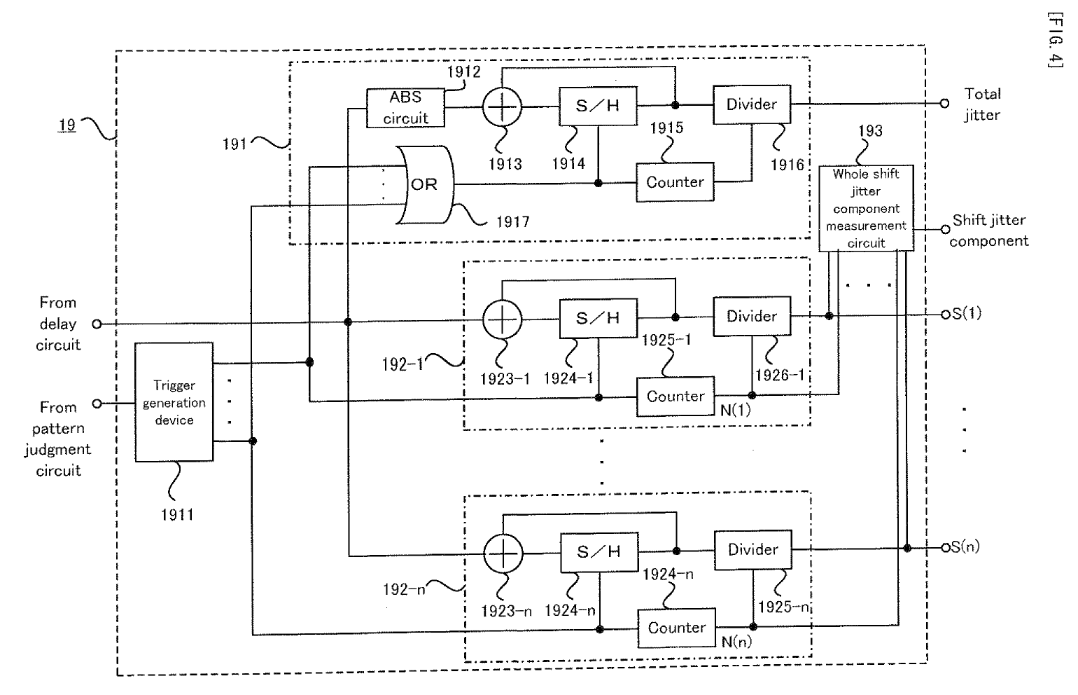

The averaging circuit 19 constitutes one specific example of the “measuring device” of the present invention. The averaging circuit 19 measures the jitter of the high-frequency emphasized read sample value series RS_{H}. The details of the averaging circuit 19 will be detailed later (refer to FIG. 3 and FIG. 4).

The pattern judgment circuit 20 constitutes one specific example of the “detecting device” of the present invention. The pattern judgment circuit 20 judges the data pattern on the basis of the binary signal outputted from the binary circuit 16. Namely, it judges which data pattern the binary signal inputted to the pattern judgment circuit 20 is. The judgment result is outputted to the averaging circuit 19.

The recording strategy adjustment circuit 21 constitutes one specific example of the “adjusting device” of the present invention. The recording strategy adjustment circuit 21 adjusts the recording strategy of each data pattern on the basis of the jitter measured on the averaging circuit 19.

(1-2) Operation Example

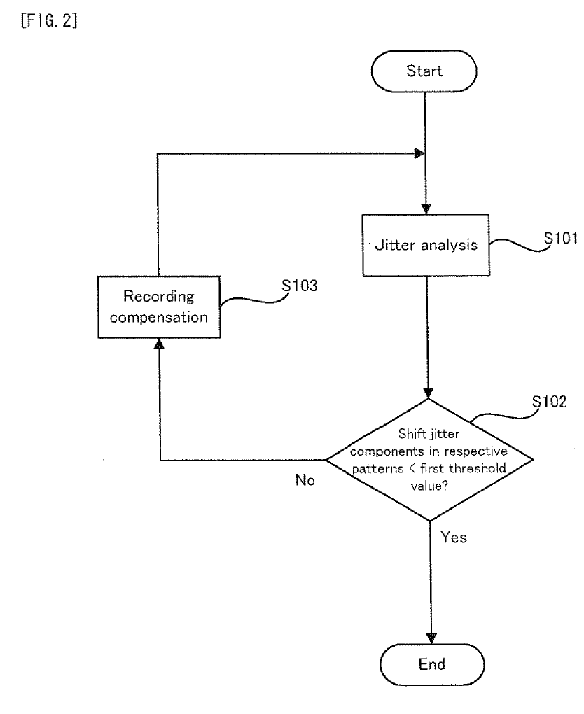

Next, with reference to FIG. 2, an explanation will be given on a first operation example of the information recording apparatus 1 in the first example (particularly, a recording compensation operation). FIG. 2 is a flowchart conceptually showing a flow of operations in the first operation example of the information recording apparatus 1 in the first example. Incidentally, FIG. 2 explains the recording compensation operation flow; however, it is obvious that a data pattern recording operation is performed in parallel with the recording compensation operation.

As shown in FIG. 2, firstly, the jitter is measured by the operation of the averaging circuit 19 (step S101).

Here, with reference to FIG. 3 and FIG. 4, an explanation will be given on the operation in measuring the jitter and the averaging circuit 19 for measuring the jitter. FIG. 3 is a waveform diagram conceptually showing an operation of measuring the jitter by the averaging circuit 19, on the (high-frequency emphasized read) sample value series RS_{H}. FIG. 4 is a block diagram conceptually showing the basic structure of the averaging circuit 19.

As shown in FIG. 3, in the example, the averaging circuit 19 firstly measures a difference (i.e. an edge shift in an amplitude direction) between a zero level and a sample value (which is shown by a black circle and which will be hereinafter referred to as a “zero cross sample value” as occasion demands) in the vicinity of the zero cross point of the (high-frequency emphasized read) sample value series RS_{H}, for each data pattern, in order to measure the jitter. If there is no intersymbol interference in the read signal R_{RF}, the sample value that approximately matches the zero level in the timing of a clock CLK is the zero cross sample value. If there is the intersymbol interference in the read signal R_{RF}, the sample value that is the closest to the zero level in the timing of the clock CLK is the zero cross sample value.

In order to perform such an operation, the averaging circuit 19 is provided with a trigger generation device 1911, a total jitter measurement block 191, n individual shift jitter component measurement blocks 192-1 to 192-n, and a whole shift jitter component measurement circuit 193, as shown in FIG. 4. The number of the individual shift jitter component measurement blocks 192-1 to 192-n is equal to the combination number of types of the data patterns. In other words, if the optical disc 100 is a DVD, there are 10 types of data run lengths (3T to 11T, and 14T). For each mark length, an individual shift jitter can be classified by using the combination pattern of front and rear space lengths. For example, there are 100 combinations of the front space length and each mark length, and there are 100 combinations of the rear space length and each mark: n=200 in total. In view of an effective pupil diameter and the data run length, the same intersymbol interference occurs in the combination patterns of the marks/spaces of 6T or more. Thus, if the data of 6T or more are treated as the same group, n can be reduced to n=32. If the optical disc 100 is a Blu-ray Disc, there are 8 types of data run lengths (2T to 9T), so that the combination patterns of the front and rear space lengths for each mark length is n=8*8*2=128 combinations. As in the DVD, in view of the effective pupil diameter and the data run length, if the data of 5T or more are treated as the same group, n can be reduced to n=32. Moreover, each of the individual shift jitter component measurement blocks 192-1 to 192-n measures corresponding one of the individual shift jitter components in the data patterns.

The high-frequency emphasized read sample value series RS_{H} outputted from the delay circuit 18 is inputted to an ABS circuit 1912 and n adders 1923-1 to 1923-n. Moreover, the pattern judgment result outputted from the pattern judgment circuit 20 is inputted to the trigger generation device 1911.

The trigger generation device 1911 generates a trigger signal which is distinguished in each data pattern and which is at high level (or low level) in timing in which the data pattern is inputted, in accordance with the pattern judgment result outputted from the pattern judgment circuit 20. The trigger signal is inputted to an OR circuit 1917, n sample hold (S/H) circuits 1924-1 to 1924-n, and n counters 1925-1 to 1925-n.

Next, the operation of the total jitter measurement block 191 will be explained. The absolute value of the zero cross sample value outputted from the ABS circuit 1912 is added on an adder 1913. The addition result is sample-held in timing in which any trigger signal is at high level (or low level) (i.e. in timing in which any data pattern is inputted to the total jitter measurement block 191), on a sample-holding circuit 1914. The result is outputted to a divider 1916 and is fed back to the adder 1913. Thus, a sum of the absolute values of the zero cross sample values of all the data patterns is outputted to the divider 1916. On the other hand, a counter 1915 counts the number of times that the trigger signal is at high level (or low level) (i.e. the number of the data patterns inputted to the total jitter measurement block 191). The count result is outputted to the divider 1916. The divider 1916 divides the sum of the absolute values of the zero cross sample values by the number of the data patterns inputted. As a result, an average value of the absolute values of the zero cross sample values is outputted. In the example, the average value of the absolute values of the zero cross sample values is a total jitter (i.e. jitter as a whole, which is taken in consideration of a random jitter component and a shift jitter component).

Next, the operation of the individual shift Jitter component measurement blocks 192-1 to 192-n will be explained. Here, an explanation will be given on the operation of the individual shift jitter component measurement block 192-1 which corresponds to the zero cross sample value of the data pattern of a 3T mark in the rear of a space with a run length of 3T when the optical disc 100 is a DVD. By the actions of the adder 1923-1 and the sample-holding circuit 1924-1, in timing in which the trigger signal corresponding to the data pattern of the 3T mark in the rear of the space with a run length of 3T is at high level (or low level) (i.e. in timing in which a boundary zero cross sample of the 3T mark in the rear of the 3T space is inputted to the individual shift jitter component measurement block 192-1), the boundary zero cross sample of the 3T mark in the rear of the 3T space is sample-held The result is outputted to a divider 1926-1 and is fed back to the adder 1923-1. In other words, on the adder 1923-1, only the boundary zero cross sample value of the 3T mark in the rear of the 3T space is integrated, and a sum of the boundary zero cross sample values of the 3T mark in the rear of the 3T space is outputted to the divider 1926-1. On the other hand, a counter 1925-1 counts the number of times N(1) that the trigger signal is at high level (or low level) (i.e. the number of the boundary zero cross samples of the 3T mark in the rear of the 3T space inputted to the individual shift jitter component measurement block 192-1). The count result is outputted to the divider 1926-1. The divider 1926-1 divides the sum of the boundary zero cross sample values of the 3T mark in the rear of the 3T space by the inputted N(1). As a result, an average value S(1) of the boundary zero cross sample values of the 3T mark in the rear of the 3T space is outputted. This operation is performed for each corresponding data pattern, on the other individual shift jitter component measurement blocks 192-2 to 192-n. In the example, the average values of the zero cross sample values in the respective data patterns are individual shift jitter components S(1) to S(n).

The individual shift jitter components S(1) to S(n) in the respective data patterns are also outputted to the whole shift jitter component measurement circuit 193. Moreover, the number of times N(1) to N(n) that the trigger signal is at high level are also outputted to the whole shift jitter component measurement circuit 193. On the whole shift jitter component measurement circuit 193, a shift jitter component as a whole taken in consideration of the occurrence probability of the individual shift jitter components in the respective data patterns is outputted by performing an arithmetic operation shown in an Equation 1.

$$\sqrt{{\sum }_{i = 1}^{n} {S ( i )}^{2} \frac{N ( i )}{{\sum }_{j = 1}^{n} N ( j )}} \qquad [ Equation 1 ]$$

In FIG. 2 again, then, it is judged whether or not the individual shift jitter components of the jitter measured in the step S101 are less than a first threshold value (step S102). The judgment is performed in each data pattern. In other words, the judgment is performed on each of the individual shift jitter components measured on the individual shift jitter component measurement blocks 192-1 to 192-n. Specifically, if the optical disc 100 is a DVD and 6T or more are treated as the same group, the judgment in the data pattern of a front space with a run length of 3T, the judgment in the data pattern of a front space with a run length of 4T, the judgment in the data pattern of a front space with a run length of 5T, and the judgment in the data pattern of a front space of a run length of 6T are performed with respect to the 3T mark. In the same manner, the judgments in the data patterns of the front spaces with run lengths of 3T, 4T, 5T, and 6T or more are performed with respect to marks with 4T or more. The judgments in the data patterns of rear spaces with run lengths of 3T, 4T, 5T, and 6T or more are performed with respect to marks with 3T, 4T, 5T, and 6T or more. Although 6T or more are treated as the unified group, if the recording compensation is performed with respect to an influence of coma aberration or the like by a tangential tilt, it is possible to treat the influenced data pattern, or individually treat 3T to 11T and 14T. On the other hand, if the optical disc 100 is a Blu-ray Disc and 5T or more are treated as the same group, the judgment in the data patterns of front spaces or rear spaces with 2T, 3T, 4T, and 5T or more is performed with respect to marks with 2T, 3T, 4T, and 5T or more. Although 5T or more are treated as the unified group, as in the DVD, if the recording compensation is performed with respect to the influence of coma aberration or the like by the tangential tilt, it is possible to treat the influenced data pattern, or individually treat 2T to 9T.

Incidentally, a value common to all the data patterns may be used as the first threshold value or an individual value for each data pattern (or each group including a plurality of data patterns) may be used as the first threshold value. Moreover, the specific value of the first threshold value, as detailed later, is preferably set to realize that a ratio of the random jitter component to the jitter is greater than or equal to a predetermined value (e.g. approximately 80% as described later).

As a result of the judgment in the step S102, if it is judged that the shift jitter components in at least one or all of the data patterns are less than the first threshold value (the step S102; Yes), the operation is ended.

On the other hand, as a result of the judgment in the step S102, if it is judged that the shift jitter components in at least one or all of the data patterns are not less than the first threshold value (the step S102: No), the recording compensation operation is performed (step S103).

Here, the recording compensation may be performed on the data pattern corresponding to the shift jitter component that is judged not to be less than the first threshold value. Alternatively, in addition to the data pattern corresponding to the shift jitter component that is judged not to be less than the first threshold value, the recording compensation may be performed on the data pattern corresponding to the shift jitter component that is judged to be less than the first threshold value.

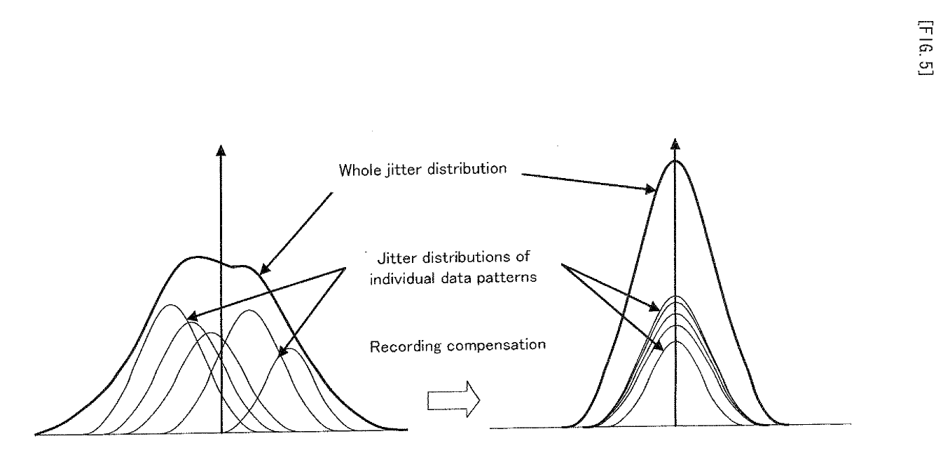

Here, with reference to FIG. 5, the recording compensation operation in the step S103 in FIG. 2 will be explained. FIG. 5 is a graph conceptually showing the states of the shift jitter components in the respective data pattern and the shift jitter component as a whole before recording compensation and the states of the shift jitter components in the respective data pattern and the shift jitter component as a whole after the recording compensation. The average value of a distribution in each data pattern is the individual shift jitter component.

As shown in FIG. 5, in the first example, such a recording compensation operation is performed that the variations spread of each of the individual shift jitter components in the respective data patterns is reduced or eliminated. More specifically, if the Jitter distributions in the respective data patterns have variations on the basis of the rising point of the clock shown by a longitudinal arrow as shown on the left side of FIG. 5, the recording compensation operation is performed such that the jitter distributions in the respective data patterns are shifted to the rising point of the clock as shown on the right side of FIG. 5. In other words, the recording compensation operation is performed such that the jitter distributions in the respective data patterns match at or in the vicinity or the rising point of the clock. In other words, the recording compensation operation is performed such that the jitter distributions in the respective data patterns are equal. As a result, the jitter distribution as a whole (i.e. total jitter distribution) is a normal distribution centered on the rising position of the clock or the like. Namely, in the recording compensation operation in the example, instead of reducing the widths of the jitter distributions in the respective data patterns (in other words, instead of reducing the random jitter component), the average values of the jitter distributions in the respective data patterns are matched. This corresponds to an operation of reducing the individual shift jitter components in the respective data patterns.

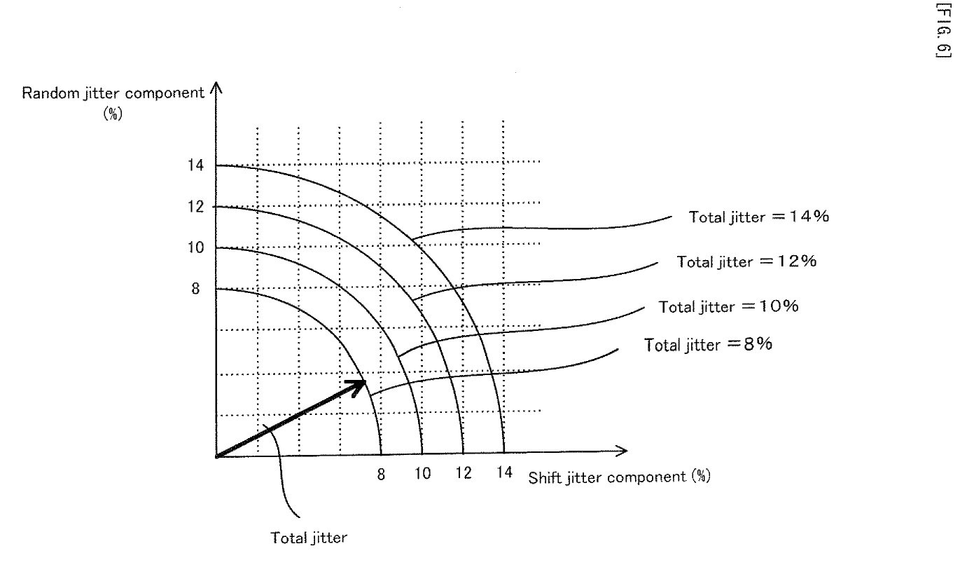

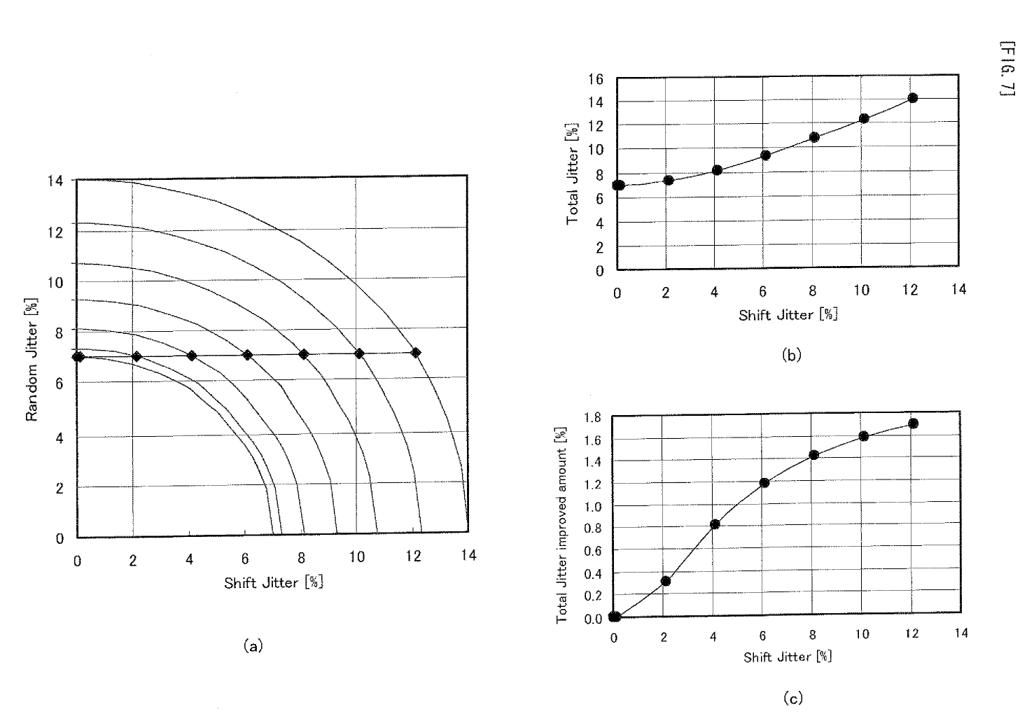

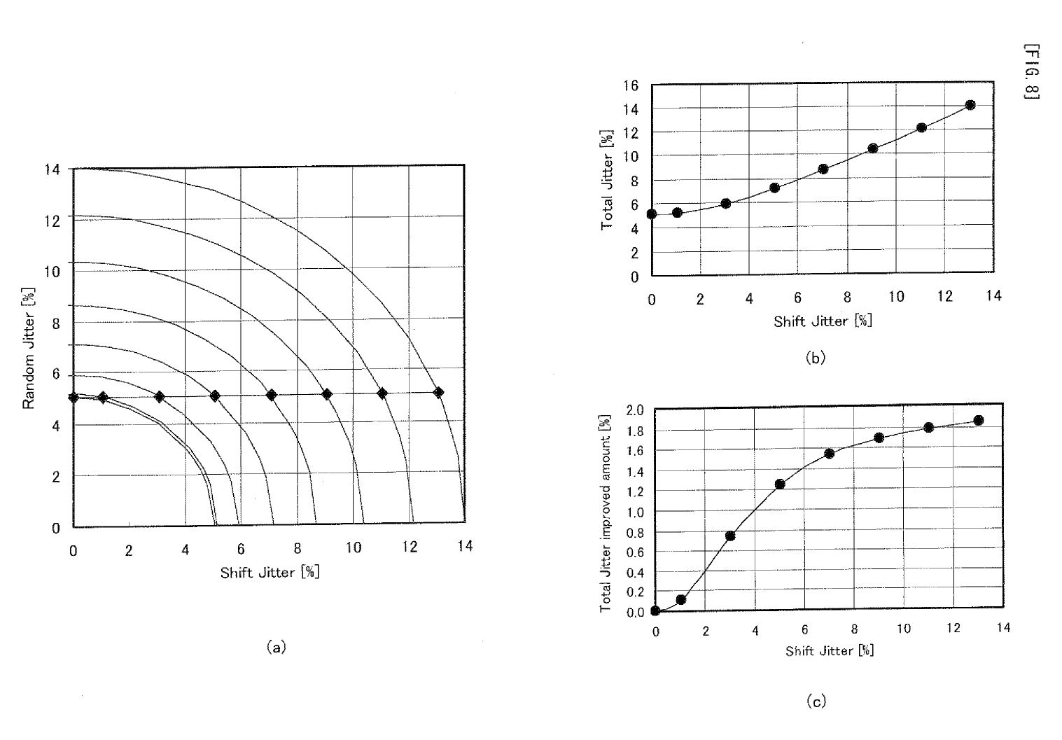

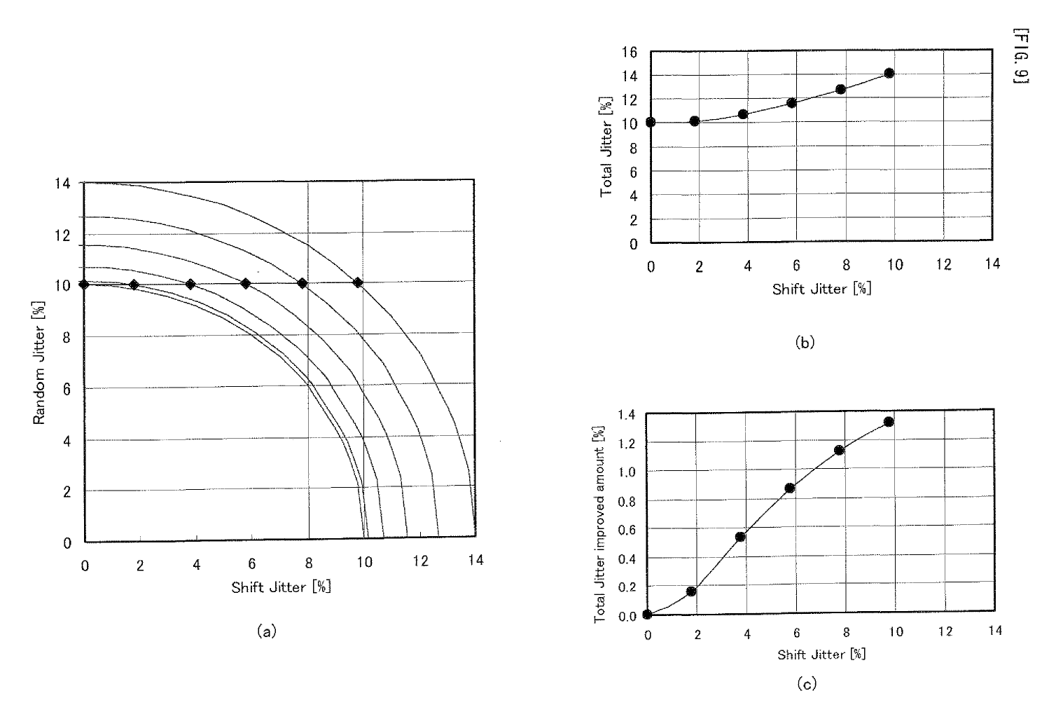

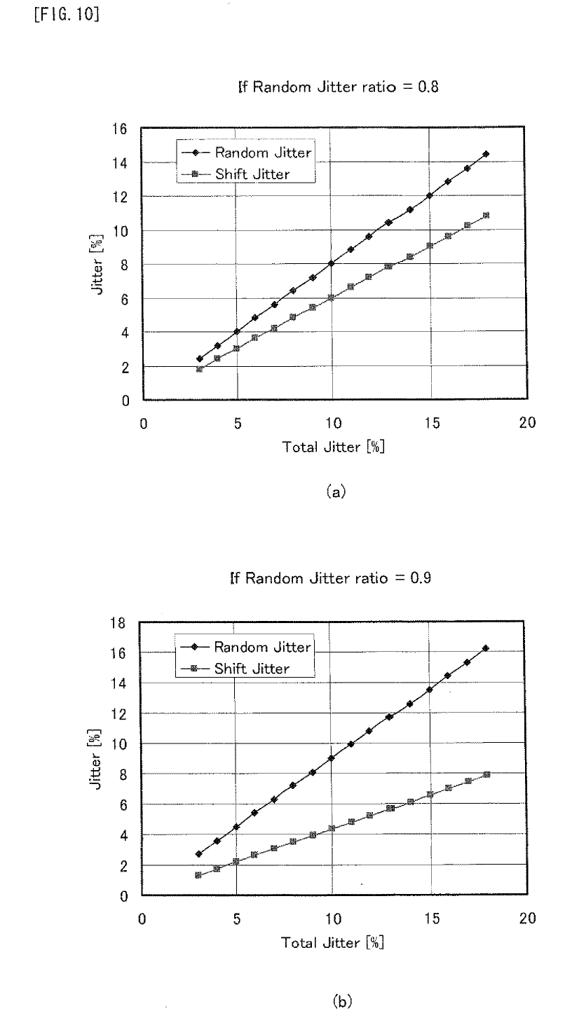

Here, the operation of reducing the shift jitter component is performed preferably in consideration of the ratio of the random jitter component to the total jitter. The operation will be explained in more details from FIG. 6 to FIG. 10. FIG. 6 is a graph conceptually showing a relation among the jitter as a whole (i.e. total jitter), the random jitter component, and the shift jitter component. FIG. 7 are graphs conceptually showing aspects of reduction in the shift jitter component if the random jitter component is 7%. FIG. 8 are graphs conceptually showing aspects of reduction in the shift jitter component if the random jitter component is 5%. FIG. 9 are graphs conceptually showing aspects of reduction in the shift jitter component if the random jitter component is 10%. FIG. 10 are other graphs conceptually showing the relation among the jitter as a whole, the random jitter component, and the shift jitter component if the ratio of the random jitter component to the total jitter is fixed.

As shown in FIG. 6, the total jitter is indicated by the square root of a sum of the square of the random jitter component and the square of the shift jitter component. In other words, if the horizontal axis is the shift jitter component and the vertical axis is the random jitter component, the total jitter is shown by a circle graph.

Here, an explanation will be given on the operation of reducing the shift jitter component in the case where the total jitter is 14% and the random jitter component is 7% before the recording compensation. In this case, as shown in FIG. 7(a), the shift jitter component before the recording compensation is approximately 12%. As shown in FIGS. 7(a) and 7(b), if the shift jitter component is reduced by every about 2%, the total jitter is gradually reduced. The graph shown in FIG. 7(c) shows the relation between the shift jitter component and a ratio of the reduced amount (i.e. improved amount) of the total jitter to the total jitter before the reduction. As seen from the graph in FIG. 7(c), the reduced amount (i.e. improved amount) of the total jitter with respect to the reduced amount of the shift jitter component is gradually reduced. This is due to the fact that the reduction in the shift jitter component is difficult to contribute to the reduction in the total jitter, because the ratio of the random jitter component to the total jitter gradually increases as the shift jitter component reduces.

Therefore, if the ratio of the random jitter component to the total jitter is greater than or equal to a certain value, it is preferable to end the reduction in the shift jitter component (i.e. the recording compensation operation) from the viewpoint of realizing the efficient recording compensation operation.

In the example shown in FIG. 7, when the shift jitter component is less than or equal to 5%, the reduced amount of the total jitter is below 1%. In other words, after the shift jitter component is 5% and thus the total jitter is 8.6%, the reduced amount of the total jitter is below 1% even if the shift jitter component is reduced. The ratio of the random jitter to the total jitter at this time is 81%. Thus, the recording compensation operation may be ended in the case where it is judged that the ratio of the random jitter component to the total jitter is greater than or equal to approximately 80% (in other words, that the reduced amount of the total jitter is less than or equal to 1%).

In the same manner, an explanation will be given on the operation of reducing the shift jitter component in the case where the total jitter is 14% and the random jitter component is 5% before the recording compensation. In this case, the shift jitter component before the recording compensation is approximately 13% as shown in FIG. 8(a). As shown in FIG. 8(a) and FIG. 8(b), if the shift jitter component is reduced by every about 2%, the total jitter is gradually reduced. The graph shown in FIG. 8(c) shows the relation between the shift jitter component and the ratio of the reduced amount (i.e. improved amount) of the total jitter to the total jitter before the reduction. As seen from the graph in FIG. 8(c), the reduced amount (i.e. improved amount) of the total jitter to the reduced amount of the shift jitter component is gradually reduced.

In the example shown in FIG. 8, when the shift jitter component is less than or equal to 4%, the reduced amount of the total jitter is below 1%. In other words, after the shift jitter component is 4% and thus the total jitter is 6.4%, the reduced amount of the total jitter is below 1% even if the shift jitter component is reduced. The ratio of the random jitter to the total jitter at this time is 78%. Thus, the recording compensation operation may be ended in the case where it is judged that the ratio of the random jitter component to the total jitter is greater than or equal to approximately 80% (in other words, that the reduced amount of the total jitter is less than or equal to 1%).

In the same manner, an explanation will be given on the operation of reducing the shift jitter component in the case where the total jitter is 14% and the random jitter component is 10% before the recording compensation. In this case, the shift jitter component before the recording compensation is approximately 10% as shown in FIG. 9(a). As shown in FIG. 9(a) and FIG. 9(b), if the shift jitter component is reduced by every about 2%, the total jitter is gradually reduced. The graph shown in FIG. 9(c) shows the relation between the shift jitter component and the ratio of the reduced amount (i.e. improved amount) of the total jitter to the total jitter before the reduction. As seen from the graph in FIG. 9(c), the reduced amount (i.e. improved amount) of the total jitter to the reduced amount of the shift jitter component is gradually reduced.

In the example shown in FIG. 9, when the shift jitter component is less than or equal to 7%, the reduced amount of the total jitter is below 1%. In other words, after the shift Jitter component is 7% and thus the total jitter is 12.2%, the reduced amount of the total jitter is below 1% even if the shift jitter component is reduced. The ratio of the random jitter to the total jitter at this time is 82%. Thus, the recording compensation operation may be ended in the case where it is judged that the ratio of the random jitter component to the total jitter is greater than or equal to approximately 80% (in other words, that the reduced amount of the total jitter is less than or equal to 1%).

The reduced amount of the total jitter depends on the reduced amount of the shift jitter component (or the corrected amount of a recording pulse). Thus, when the ratio of the random jitter component to the total jitter is used as the condition for ending the recording compensation operation, there is little influence of the setting variations of the recording compensation.

In the case where the ratio of the random jitter component to the total jitter is approximately 80% as shown in FIG. 7 to FIG. 9, the relation among the jitter as a whole, the random jitter component, and the shift jitter component is shown by the graph shown in FIG. 10(a). According to the graph shown in FIG. 10(a), if the value of the total jitter is measured, it is possible to relatively easily recognize what value of the shift jitter component causes the ratio of the random jitter component to the total jitter to be approximately 80%. For example, if the total jitter is approximately 10%, the ratio of the random jitter component to the total jitter is approximately 80% when the shift jitter component is set to approximately 6%. Therefore, in this case, if the shift jitter component is less than or equal to 6% due to the recording compensation operation, the ratio of the random jitter component to the total jitter is approximately 80%, so that the recording compensation operation can be ended. In the same manner, for example, if the total jitter is approximately 15%, the ratio of the random jitter component to the total jitter is approximately 80% when the shift jitter component is set to approximately 9%. Therefore, in this case, if the shift jitter component is less than or equal to 9% due to the recording compensation operation, the ratio of the random jitter component to the total jitter is approximately 80%, so that the recording compensation operation can be ended. As described above, the target value of the shift jitter component can be relatively easily found with reference to the relation between the total jitter and the shift jitter component shown by the graph shown in FIG. 10(a), if the value of the total jitter is measured.

Incidentally, although the recording compensation operation may be performed such that the ratio of the random jitter component to the total jitter is greater than or equal to approximately 80%, in order to reduce the total jitter more, the recording compensation operation may be performed such that the ratio of the random jitter component to the total jitter is greater than or equal to approximately 90%. In this case, the target value of the shift jitter component can be relatively easily found with reference to the relation between the total jitter and the shift jitter component shown by the graph shown in FIG. 10(b).

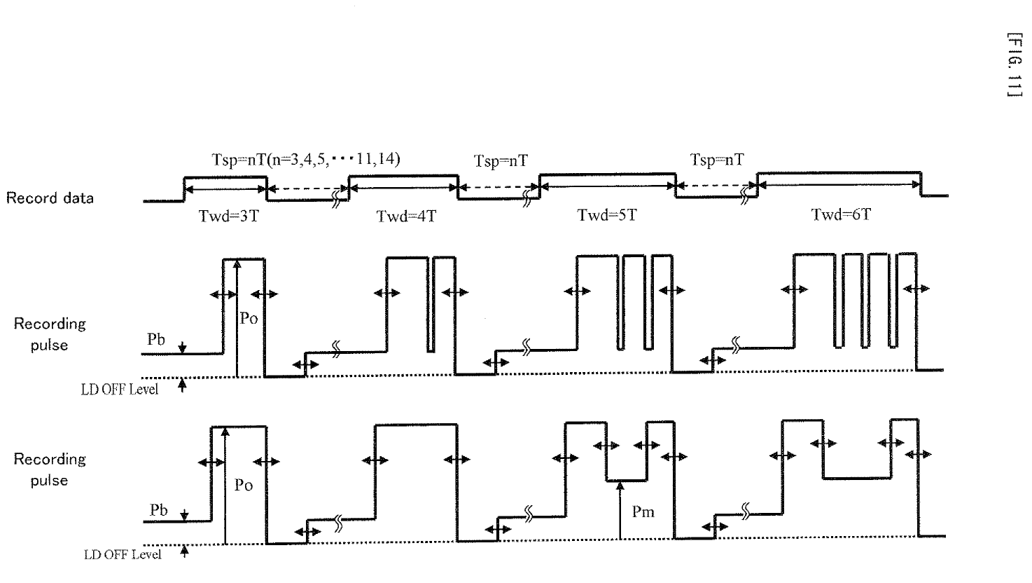

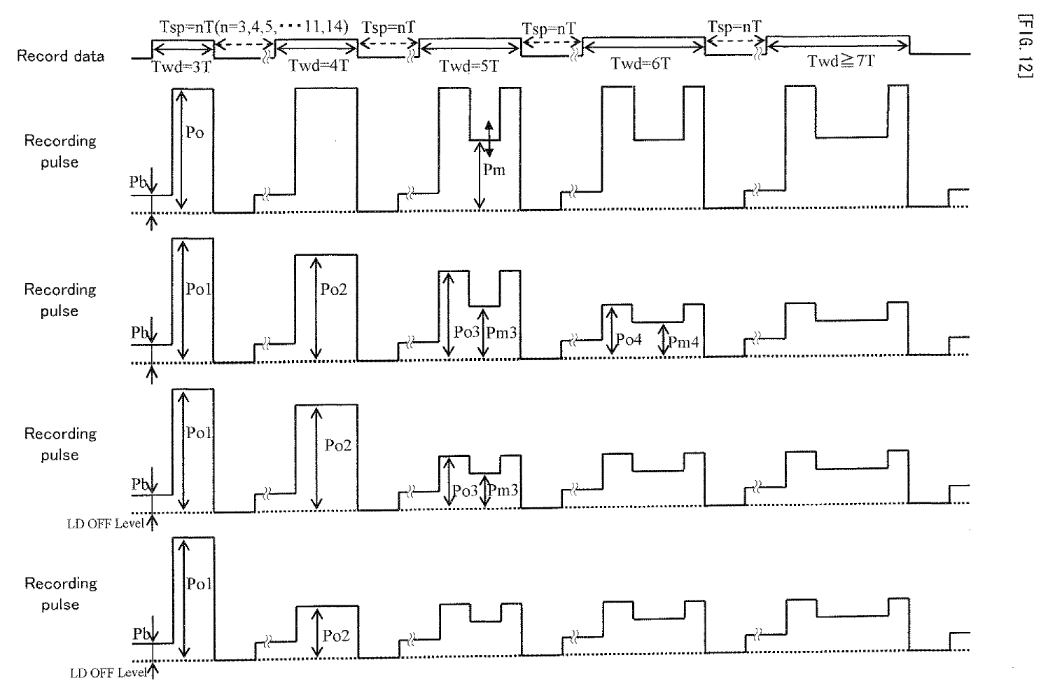

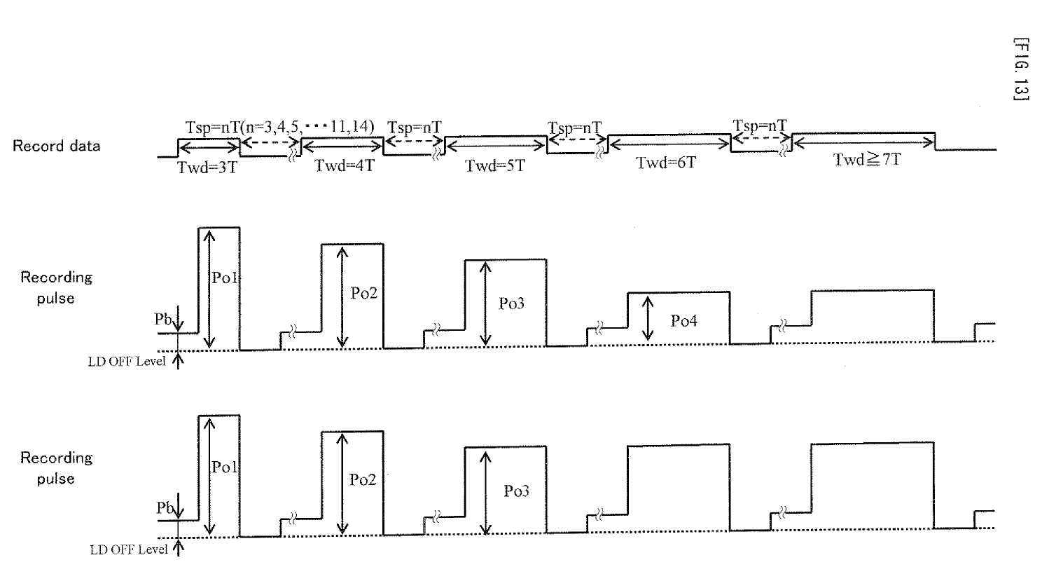

As described above, the shift jitter components in the respective data patterns are reduced such that the ratio of the random jitter component to the total jitter is greater than or equal to approximately 80% or approximately 90%. Moreover, in order to reduce the individual shift jitter components in the respective data patterns, the recording strategy adjustment circuit 21 adjusts the recording strategy, for example, as shown in FIG. 11 to FIG. 13. FIG. 11 is a timing chart conceptually showing a first aspect of a recording strategy adjustment operation. FIG. 12 is a timing chart conceptually showing a second aspect of the recording strategy adjustment operation. FIG. 13 is a timing chart conceptually showing a third aspect of the recording strategy adjustment operation.

For example, as shown in FIG. 11, the pulse width of a recording pulse (i.e. recording strategy) which defines the waveform of the laser beam for the data pattern (record data) may be adjusted.

Moreover, as shown in FIG. 12, the amplitudes (e.g. a top pulse amplitude Po, a middle pulse amplitude Pm, a bottom pulse amplitude Pb) of the recording pulse (i.e. recording strategy) which define the waveform of the laser beam for the data pattern (record data) may be adjusted. Here, as shown in the recording pulse on the top in FIG. 12, the amplitudes of the recording pulse corresponding to the data patterns with run lengths of 3T and 4T and the amplitudes of the recording pulse corresponding to the data patterns with run lengths of 5T or more may be separately adjusted. Alternatively, as shown in the second recording pulse from the top in FIG. 12, the amplitudes of the recording pulse corresponding to the data pattern with a run length of 3T, the amplitudes of the recording pulse corresponding to the data pattern with a run length of 4T, the amplitudes of the recording pulse corresponding to the data pattern with a run length of 5T. and the amplitudes of the recording pulse corresponding to the data pattern with run lengths of 6T or more may be separately adjusted. Alternatively, as shown in the third recording pulse from the top in FIG. 12, the amplitudes of the recording pulse corresponding to the data pattern with a run length of 3T, the amplitudes of the recording pulse corresponding to the data pattern with a run length of 4T, and the amplitudes of the recording pulse corresponding to the data pattern with run lengths of 5T or more may be separately adjusted. Alternatively, as shown in the fourth recording pulse from the top in FIG. 12, the amplitudes of the recording pulse corresponding to the data pattern with a run length of 3T and the amplitudes of the recording pulse corresponding to the data pattern with run lengths of 4T or more may be separately adjusted.

Moreover, as shown in FIG. 13, even if the recording pulse is not of a castle type, as in the case shown in FIG. 12, the amplitudes of the recording pulse (i.e. the recording strategy) which define the waveform of the laser beam for recording the data pattern (or record data) may be adjusted.

Of course, it is obvious that the recording strategy may be adjusted by combining the adjustment of the pulse width of the recording pulse as shown in FIG. 11 and the adjustment of the amplitudes of the recording pulse as shown in FIG. 12 and FIG. 13, as occasion demands.

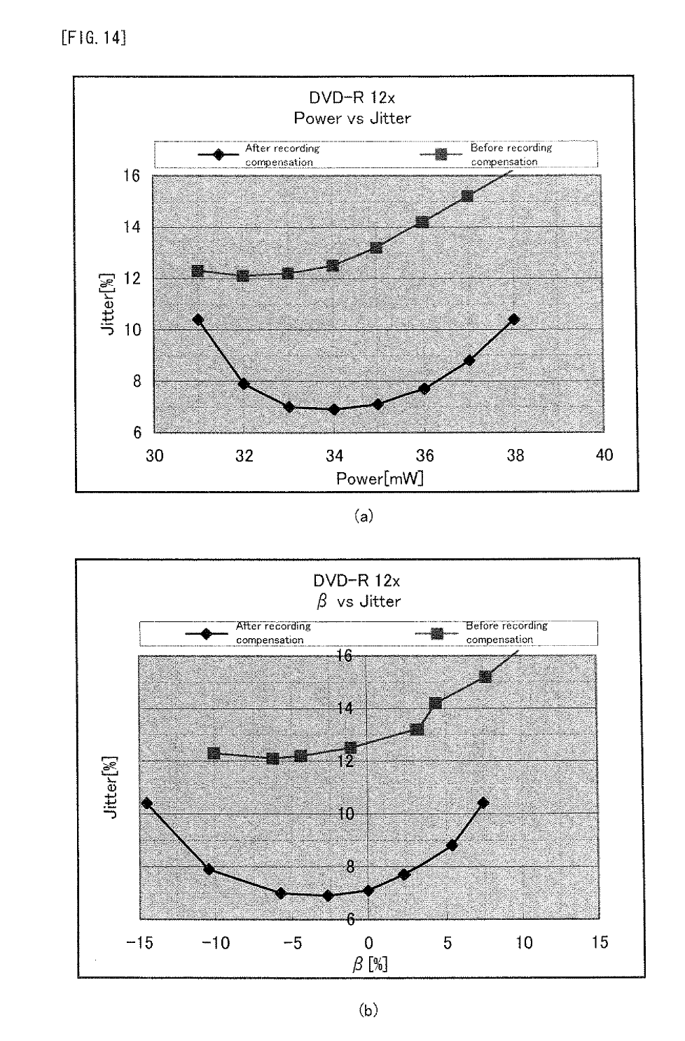

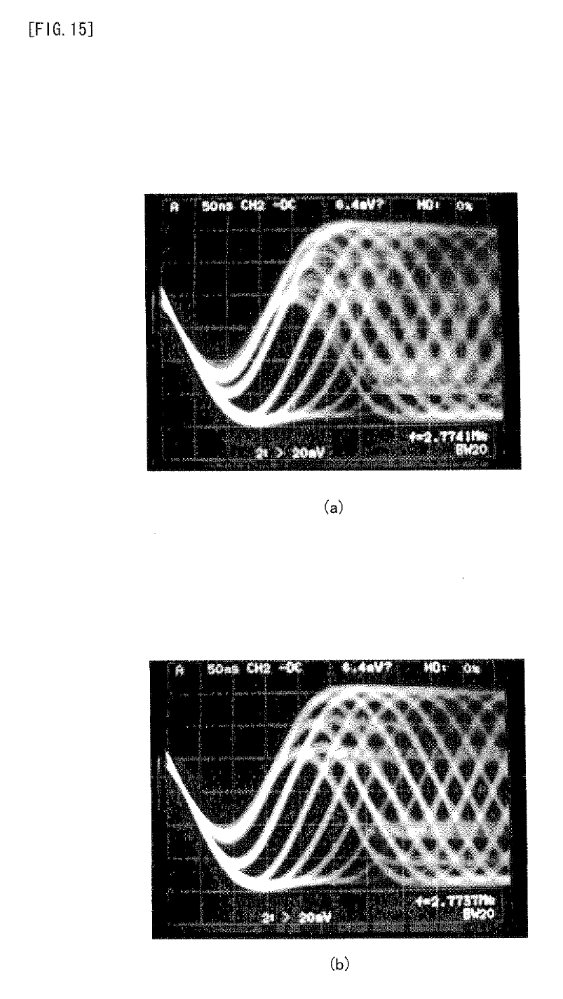

As explained above, according to the information recording apparatus 1 in the example, it is possible to reduce the total jitter by performing the recording compensation operation. Here, with reference to FIG. 14 and FIG. 15, a total-jitter reduction effect will be explained. FIG. 14 are graphs conceptually showing a relation of a recording power vs. the total jitter and a relation of a β value vs. the total jitter before and after the recording compensation. FIG. 15 are waveform diagrams conceptually showing a read signal before and after the recording compensation. Incidentally, it is assumed that the pulse width and the amplitude of the recording pulse are set to those included in DI information before the recording compensation. Incidentally, FIG. 14 and FIG. 15 show a result when a DVD-R is used as one example of the optical disc 100 and 12-time speed recording is performed.

As shown in FIG. 14(a), the jitter value which has a value of approximately 12% or more before the recording compensation is reduced to be less than or equal to approximately 8% (or 10%) by the recording compensation operation performed by the information recording apparatus 1 in the example. In the same manner, as shown in FIG. 14(b), the jitter value which has a value of approximately 12% or more before the recording compensation is reduced to be less than or equal to approximately 8% (or 10%) by the recording compensation operation performed by the information recording apparatus 1 in the example. As a result, the eye pattern of the read signal which is unclear before the recording compensation as shown in FIG. 15(a) becomes clear after the recording compensation as shown in FIG. 15(b).

In addition, in the example, the recording compensation operation is performed while the pattern judgment is performed by using the output of the limit equalizer 15 (i.e. the high-frequency emphasized read sample value series RS_{H}). In other words, the recording compensation operation is performed while the pattern judgment is performed in the situation that the amplification level of the shortest data pattern is emphasized. In any state of the asymmetry of the read signal, it is possible to preferably prevent the situation that the shortest data pattern included in the read signal does not cross the zero level. As a result, it is possible to preferably detect the shortest data pattern. By this, it is possible to preferably perform the recording compensation operation with respect to the read signal including the shortest data pattern. In other words, the recording compensation operation can be preferably performed regardless of the state of the asymmetry in the read signal before the recording compensation.

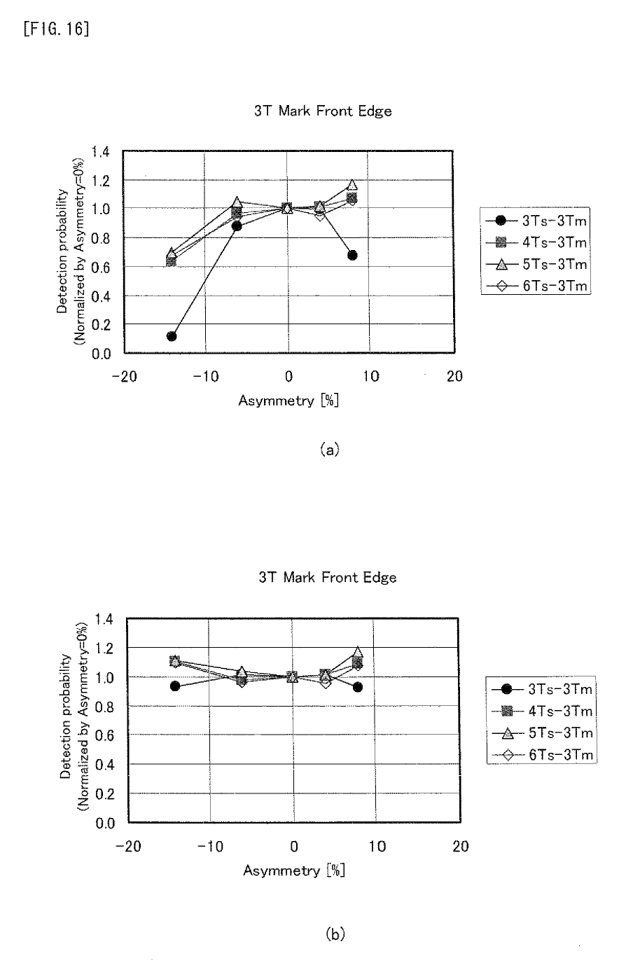

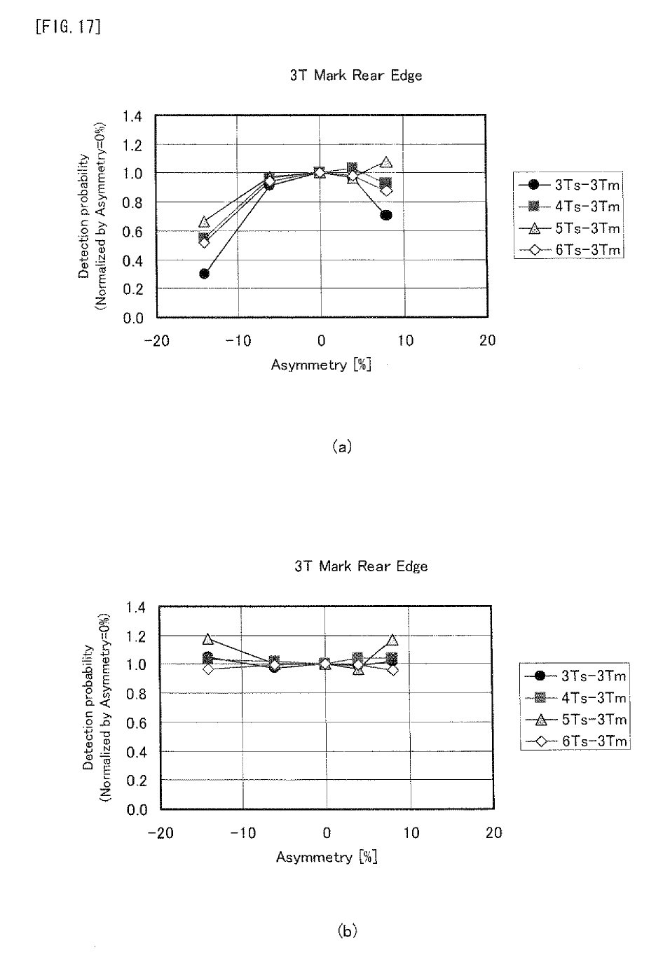

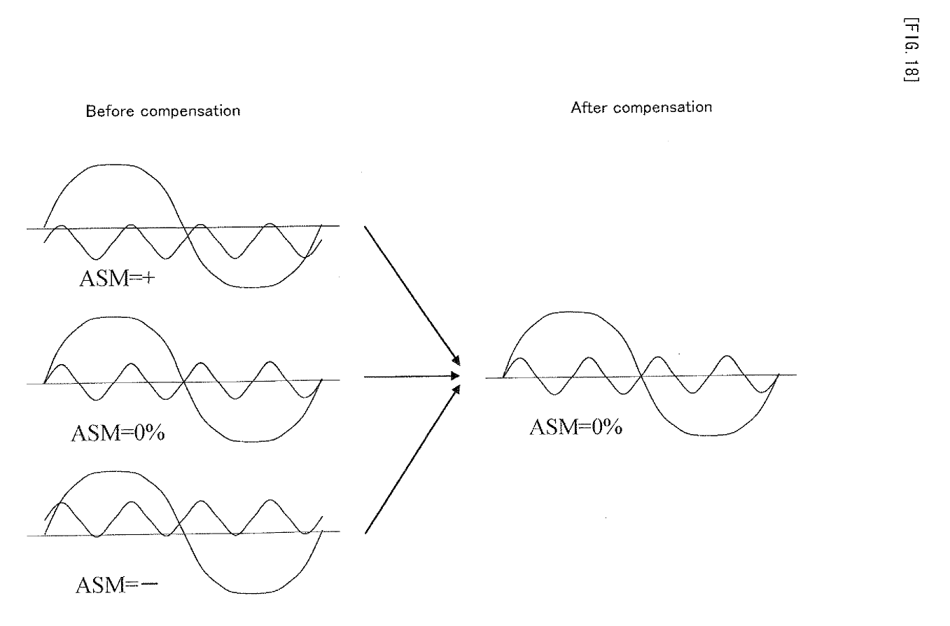

The effect that the recording compensation operation can be preferably performed regardless of the state of the asymmetry in the read signal before the recording compensation will be explained in more details with reference to FIG. 16 to FIG. 18. FIG. 16 are graphs conceptually showing the detection probability (normalized by the detection probability when the asymmetry is 0) of a front edge of the shortest data pattern included in the read signal outputted from the limit equalizer 15 and the detection probability (normalized by the detection probability when the asymmetry is 0) of a front edge of the shortest data pattern included in the read signal outputted from the pre-equalizer 14. FIG. 17 are graphs conceptually showing the detection probability (normalized by the detection probability when the asymmetry is 0) of a rear edge of the shortest data pattern included in the read signal outputted from the limit equalizer 15 and the detection probability (normalized by the detection probability when the asymmetry is 0) of a rear edge of the shortest data pattern included in the read signal outputted from the pre-equalizer 14. FIG. 18 is a waveform diagram conceptually showing a relation between the read signal and asymmetry before and after the recording compensation. Incidentally, in FIG. 16 and FIG. 17, an explanation will be given on an example when a DVD is used as the optical disc 100.

As shown in FIG. 16(a) and FIG. 17(a), the front edge and the rear edge of the shortest data pattern included in the read signal outputted from the pre-equalizer 14 have relatively bad detection probabilities. This is because there is relatively large positive asymmetry or relatively small negative asymmetry, which causes the shortest data pattern included in the read signal to hardly cross the zero level, so that the shortest data pattern cannot be detected.

On the other hand, as shown in FIG. 16(b) and FIG. 17(b), the front edge and the rear edge of the shortest data pattern included in the read signal outputted from the limit equalizer 15 have relatively good detection probabilities. This is because the recording compensation operation is performed while the jitter is measured in the situation that the amplitude level of the shortest data pattern is emphasized, so that it is possible to preferably prevent the situation that the shortest data pattern included in the read signal does not cross the zero level in any state of the asymmetry of the read signal before the recording compensation.

As a result, as shown in FIG. 18, the recording compensation operation can be performed regardless of the state of the asymmetry in the read signal before the recording compensation. As a result, the jitter can be reduced, and the asymmetry can be set to approximately 0.

Incidentally, the pulse width and the amplitude may be adjusted, preferentially from the recording pulse corresponding to the data pattern with a relatively large shift jitter component. In this case, it is possible to reduce the shift jitter component more efficiently, resulting in more efficient reduction in the total jitter.

(1-3) Second Operation Example

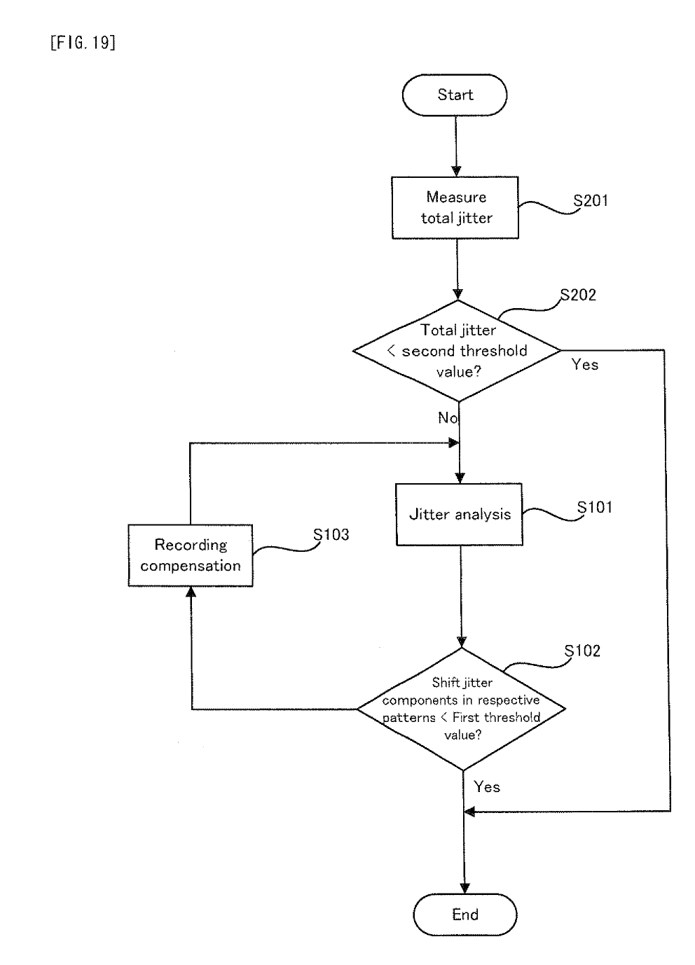

Next, with reference to FIG. 19, a second operation example of the information recording apparatus 1 in the first example will be explained. FIG. 19 is a flowchart conceptually showing a flow of operations in the second operation example of the information recording apparatus 1 in the first example. Incidentally, the same operation as that in the aforementioned first operation example will carry the same step number, and the detailed explanation thereof will be omitted.

As shown in FIG. 19, firstly, by the operation of the averaging circuit 19, the total jitter is measured (step S201). Then, it is judged whether or not the total jitter is less than or equal to a second threshold value (step S202). The second threshold value used here may be, for example, a value determined in the standard of the optical disc 100 or a jitter value that does not influence the recording operation or reproduction operation. Alternatively, the second threshold value may be, for example, 12%, 10%, 8%, or less.

As a result of the judgment in the step S202, if it is judged that the total jitter is less than or equal to the second threshold value (the step S202: Yes), the operation is ended without the recording compensation operation.

On the other hand, as a result of the judgment in the step S202, if it is judged that the total jitter is not less than or equal to the second threshold value (the step S202: No), the recording compensation operation explained in the first operation example (i.e. the operation in the step S101 to the step S103) is performed.

As described above, according to the second operation example, it is possible to preferably receive the same effects as those that can be received in the first operation example. In addition, if the total jitter is less than or equal to the second threshold value (i.e. if the total jitter is good), the recording compensation operation is not necessarily performed. Thus, it is possible to reduce the operation load of the information recording apparatus 1.

### (2) Second Example

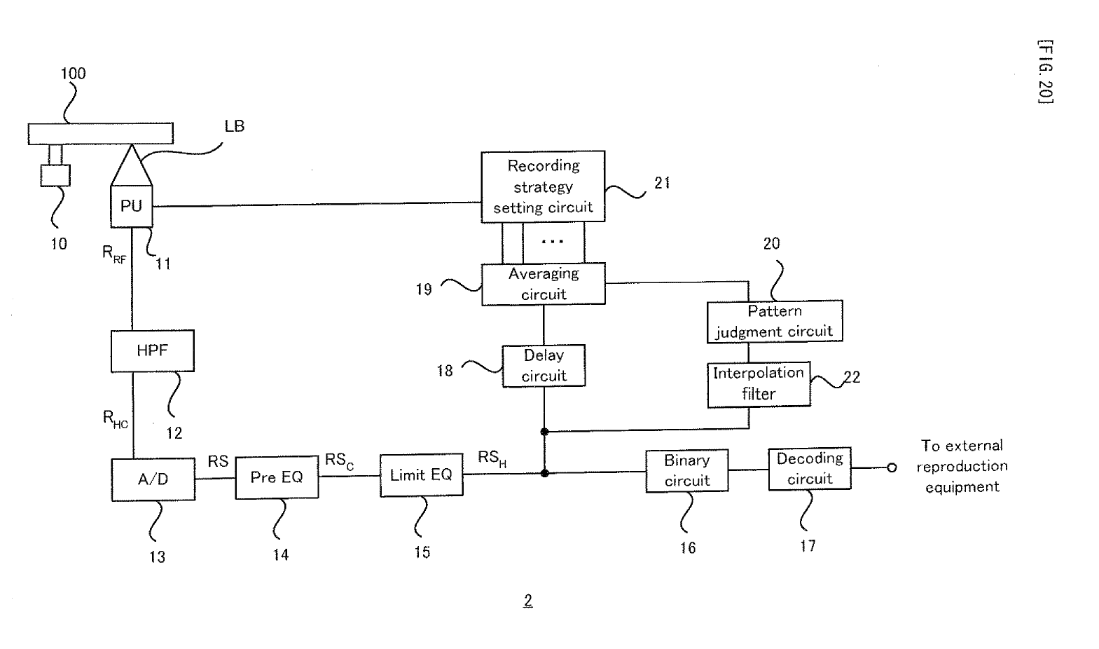

Next, with reference to FIG. 20, a second example of the information recording apparatus of the present invention will be explained. FIG. 20 is a block diagram conceptually showing the basic structure of the information recording apparatus in the second example. Incidentally, the same constituents as those of the aforementioned information recording apparatus 1 in the first example will carry the same referential numerals, and the explanation thereof will be omitted.

As shown in FIG. 20, an information recording apparatus 2 in the second example is provided with a spindle motor 10, a pickup 11, a HPF 12, an A/D converter 13, a pre-equalizer 14, a limit equalizer 15, a binary circuit 16, a decoding circuit 17, a delay circuit 18, an averaging circuit 19, a pattern judgment circuit 20, and a recording strategy adjustment circuit 21, as in the information recording apparatus 1 in the first example.

The information recording apparatus 2 in the second example is provided particularly with an interpolation filter 22. The interpolation filter 22 interpolates the high-frequency emphasized read sample value series RS_{H} outputted from the limit equalizer 15, thereby obtaining an interpolated sample value. Moreover, the high-frequency emphasized read sample value series RS_{H} is outputted to the pattern judgment circuit 20 with the interpolated sample value.

As described above, in the second example, instead of a binary signal outputted from the binary circuit 16, the high-frequency emphasized read sample value series RS_{H} outputted from the limit equalizer 15 is used to perform the pattern judgment. In other words, on the pattern judgment circuit 20, the data pattern is judged on the basis of the continuity of sign bits of the high-frequency emphasized read sample value series RS_{H}.

In particular, if a viterbi decoding circuit or the like is used for the binary circuit 16, the step number of the binary circuit 16 is large, so that the amount of delay set on the delay circuit 18 increases. On the delay circuit 18, for example, it is necessary to delay by a time required to binarize an 8-bit reproduction signal sample value by viterbi decoding, which causes a large scale of the delay circuit. In order to reproduce user data, it is important to use the limit equalizer 15 and the viterbi decoding to improve a reproduction error rate; however, if it is only to detect the average strategy deviation of the individual data patterns, a sufficient performance can be obtained in the pattern judgment from the output signal of the limit equalizer 15 without using the viterbi decoding. Thus, it is extremely preferable that the pattern judgment can be performed without the process on the binary circuit 16, from the viewpoint of a reduction in the circuit scale of the delay circuit 18.

### (3) Third Example

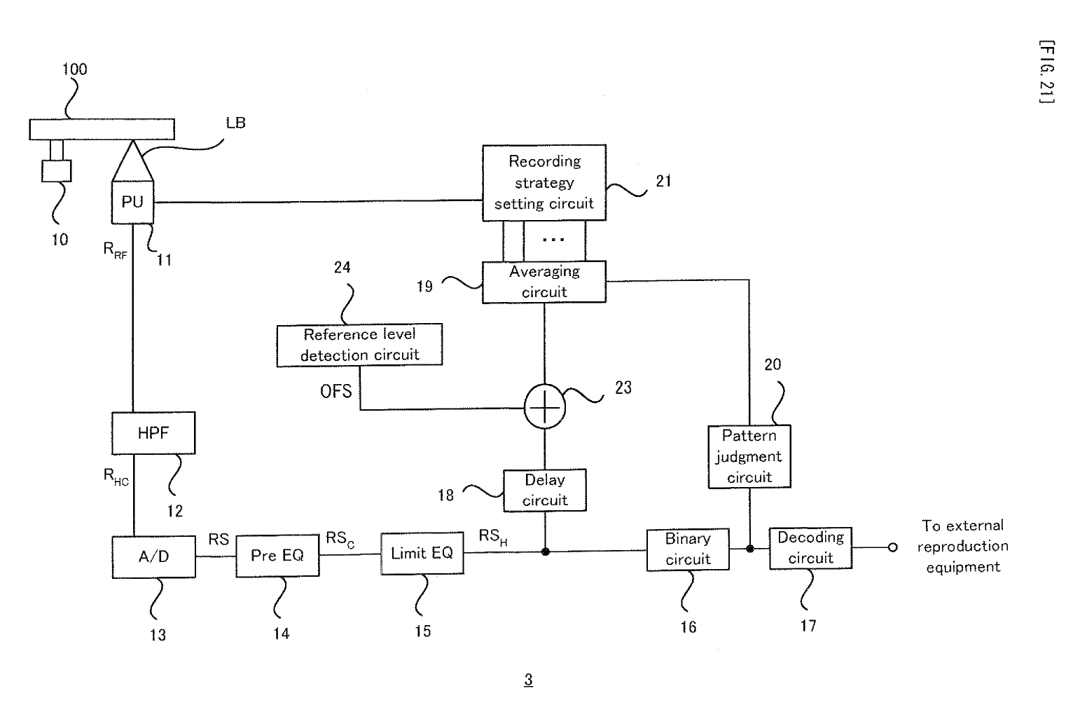

Next, with reference to FIG. 21 to FIG. 34, a third example of the information recording apparatus in a third example will be explained.

(3-1) Basic Structure

Firstly, with reference to FIG. 21, the basic structure of the information recording apparatus in the third example will be explained. FIG. 21 is a block diagram conceptually showing the basic structure of the information recording apparatus in the third example.

As shown in FIG. 21, an information recording apparatus 3 in the third example is provided with a spindle motor 10, a pickup 11, a HPF 12, an A/D converter 13, a pre-equalizer 14, a limit equalizer 15, a binary circuit 16, a decoding circuit 17, a delay circuit 18, an averaging circuit 19, a pattern judgment circuit 20, and a recording strategy adjustment circuit 21, as in the information recording apparatus 1 in the first example.

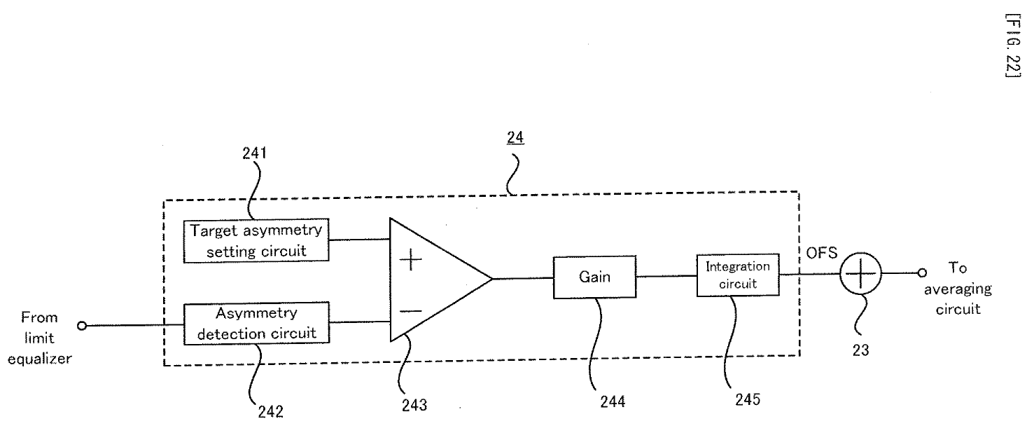

The information recording apparatus 3 in the third example is provided particularly with an adder 23 and a reference level detection circuit 24, each of which constitutes one specific example of the “adding device” of the present invention. Here, with reference to FIG. 22, the adder 23 and the reference level detection circuit 24 will be explained. FIG. 22 is a block diagram conceptually showing a relation between the basic structure of the reference level detection circuit 24 and the adder 23 provided for the information recording apparatus 3 in the third example.

As shown in FIG. 22, the high-frequency emphasized read sample value series RS_{H} outputted from the limit equalizer 15 is added to the output of the reference level detection circuit 24 on the adder 23.

The reference level detection circuit 24 is provided with a target asymmetry setting circuit 241, an asymmetry detection circuit 242, a comparator 243, a gain circuit 244, and an integration circuit 245.

The addition result on the adder 23 is outputted to the averaging circuit 19 and the asymmetry detection circuit 242. On the asymmetry detection circuit 242, the asymmetry of the read signal is detected. The detected asymmetry is outputted to the comparator 243. On the other hand, on the target asymmetry setting circuit 241, the target asymmetry of the read signal after the recording compensation is set. The set target asymmetry is outputted to the comparator 243. On the comparator 243, a difference between the detected asymmetry and the target asymmetry is detected. The detected difference is integrated on the integration circuit 245 after a gain is adjusted on the gain circuit 244. The integration result is outputted to the adder 23 as offset and is added to the high-frequency emphasized read sample value series RS_{H} outputted from the limit equalizer 15. In other words, the offset corresponding to the difference between the detected asymmetry and the target asymmetry is added to the high-frequency emphasized read sample value series RS_{H} outputted from the limit equalizer 15. By this, it is possible to set the reference level of the high-frequency emphasized read sample value series RS_{H} to a desired value.

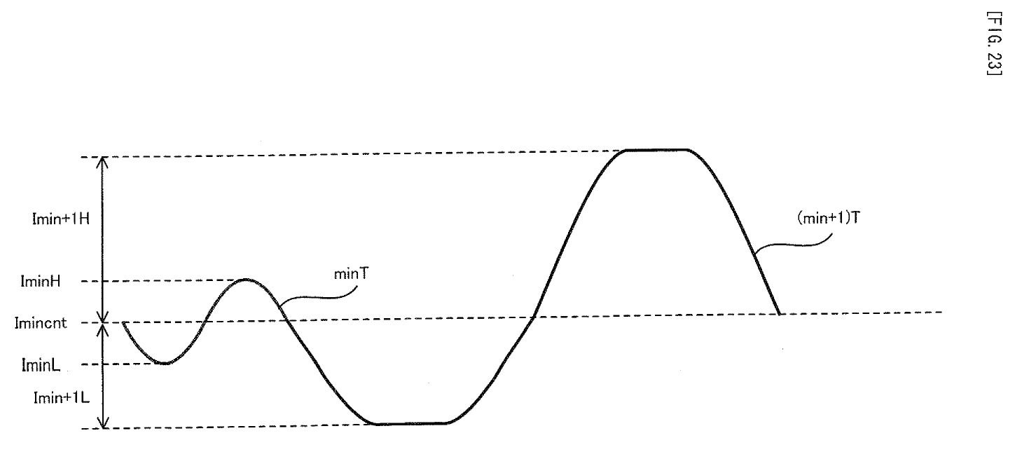

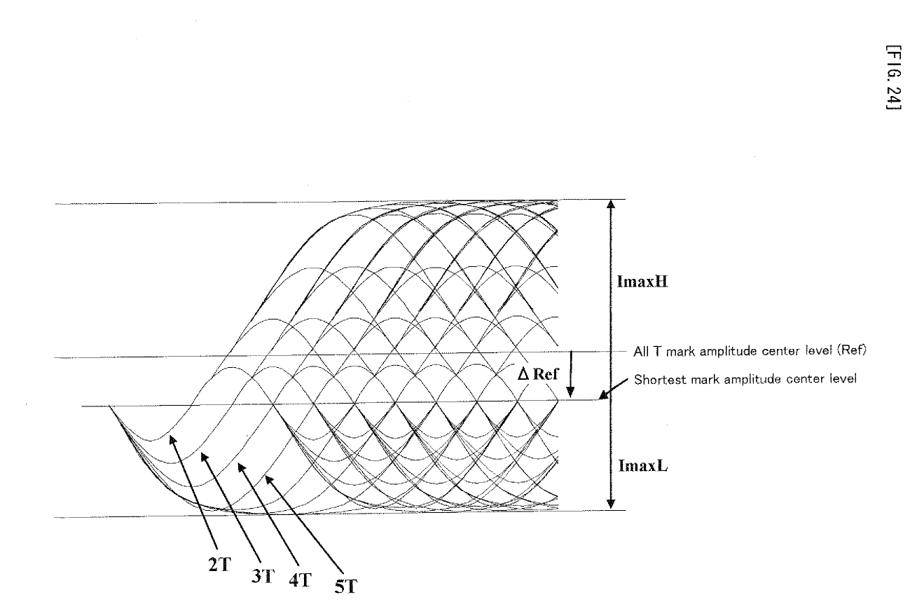

Incidentally, a signal detected from the read signal on the reference level detection circuit 24 is not limited to the aforementioned asymmetry but may be a β value, or a partial β value or an α value shown in FIG. 23 and FIG. 24 below. FIG. 23 is a waveform diagram conceptually showing the partial β value. FIG. 24 is a waveform diagram conceptually showing the α value.

As shown in FIG. 23, the partial β value indicates the deviation between the amplitude center of the read signal corresponding to the record data with the shortest run length and the amplitude center of the read signal corresponding to the record data with the second shortest run length. Specifically, the partial β value=(Imin+1H+Imin+1L)/(Imin+1H−Imin+1L), wherein the amplitude center of the read signal corresponding to the record data with the shortest run length is IminCnt, Imin+1H indicates the magnitude of the top amplitude of the read signal R_{RF} corresponding to the record data with the second shortest run length based on IminCnt, and Imin+1L indicates the magnitude of the bottom amplitude of the read signal R_{RF} corresponding to the record data with the second shortest run length based on IminCnt. Incidentally, IminCnt is an average value of the top amplitude value IminH and the bottom amplitude value IminL of the read signal corresponding to the record data with the shortest run length.

In this case, it is obvious that the target asymmetry setting circuit 241 and the asymmetry detection circuit 242 in FIG. 22 are a partial β value setting circuit and a partial β value detection circuit, respectively.

Next, with reference to FIG. 24, the a value will be explained. The α value indicates a deviation ratio (or rate) of the amplitude center of the read signal corresponding to the record data with the shortest run length, with respect to the amplitude center (i.e. the reference level, and the zero level in the example) of the read signals corresponding to the respective record data with all types of run lengths (e.g. the record data with each of run lengths of 3T to 11T and 14T if the optical disc 100 is a DVD, and the record data with each of run lengths of 2T to 9T if the optical disc 100 is a Blu-ray Disc). Specifically, a value=ΔRef/(ImaxH−ImaxL), wherein ImaxH is the magnitude of the top amplitude of the read signal corresponding to the data with the longest run length based on the amplitude center of the read signal corresponding to the record data with all types of run lengths (i.e. all T center level), ImaxL is the magnitude of the bottom amplitude of the read signal corresponding to the data with the longest run length based on the amplitude center of the read signals corresponding to the record data with all types of run lengths (i.e. all T center level), and ΔRef is a shift amount of the amplitude center of the read signal corresponding to the record data with the shortest run length, with respect to the amplitude center of the read signals corresponding to the record data with all types of run lengths.

In this case, it is obvious that the target asymmetry setting circuit 241 and the asymmetry detection circuit 242 in FIG. 22 are an value setting circuit and an a value detection circuit, respectively

By adopting such a structure, the information recording apparatus 3 in the third example changes the reference level, thereby arbitrarily setting the asymmetry of the read signal after the recording compensation. Hereinafter, the detailed operation will be explained.

(3-2) First Operation Example

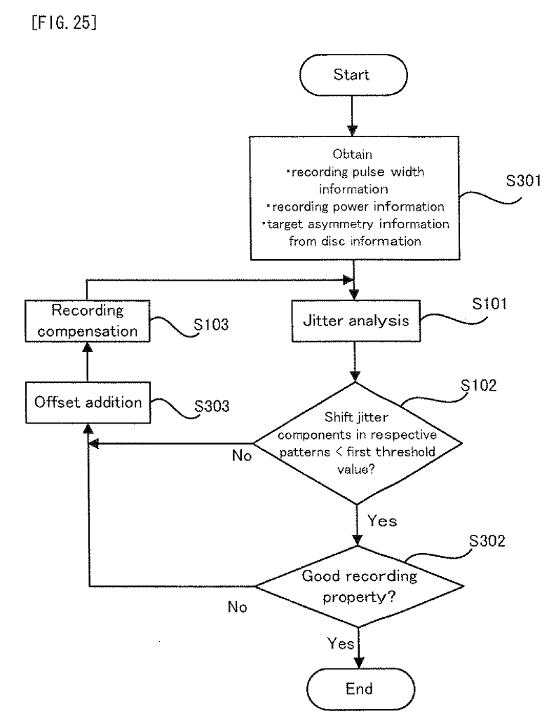

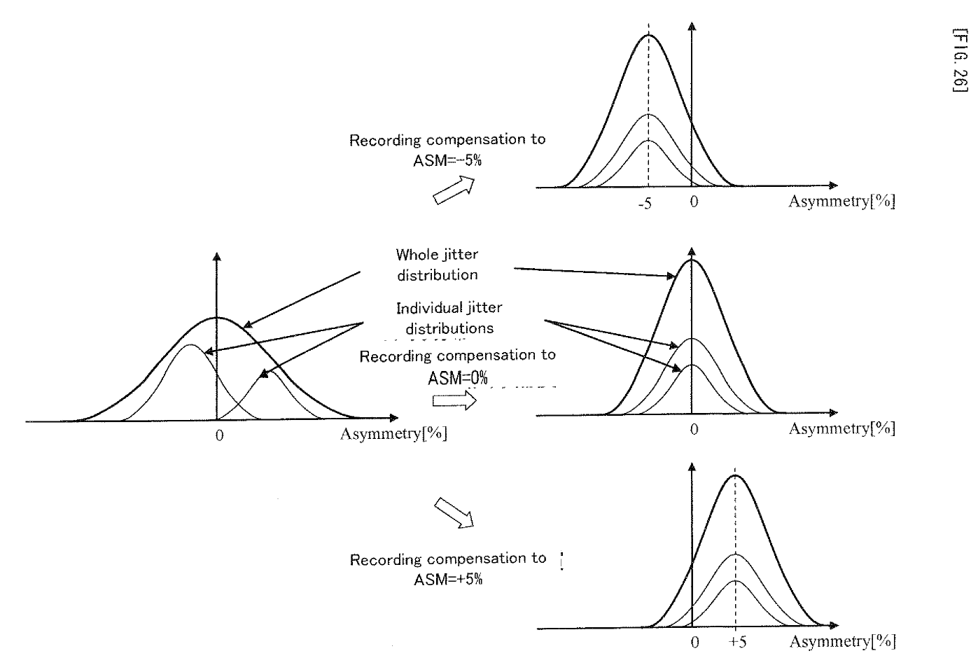

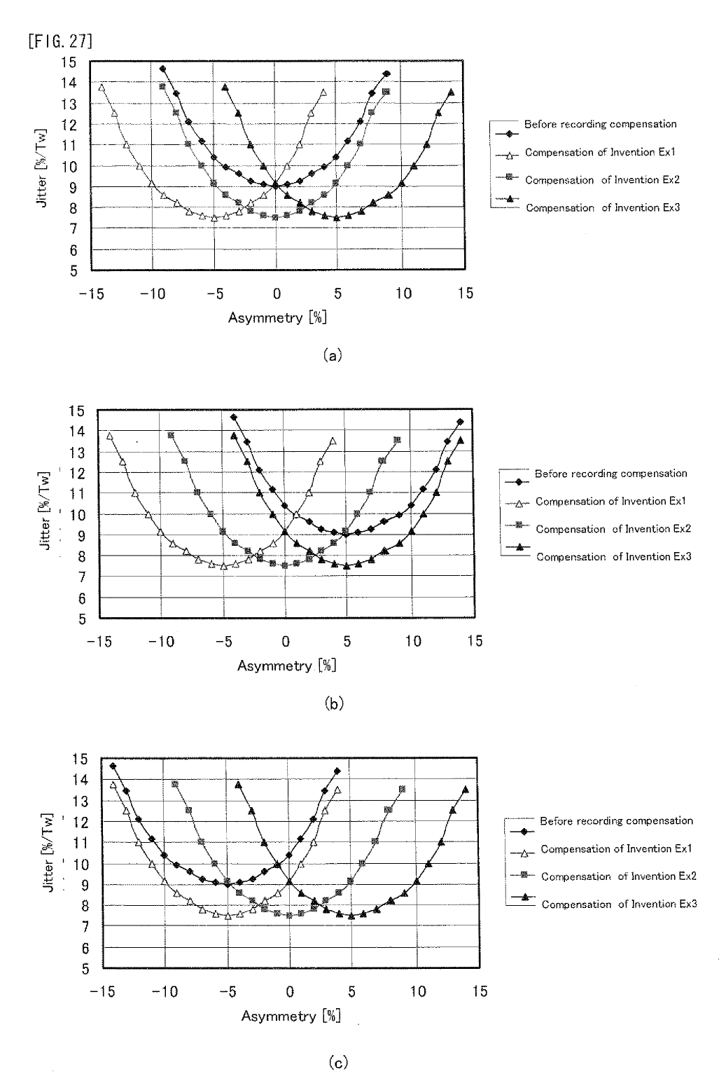

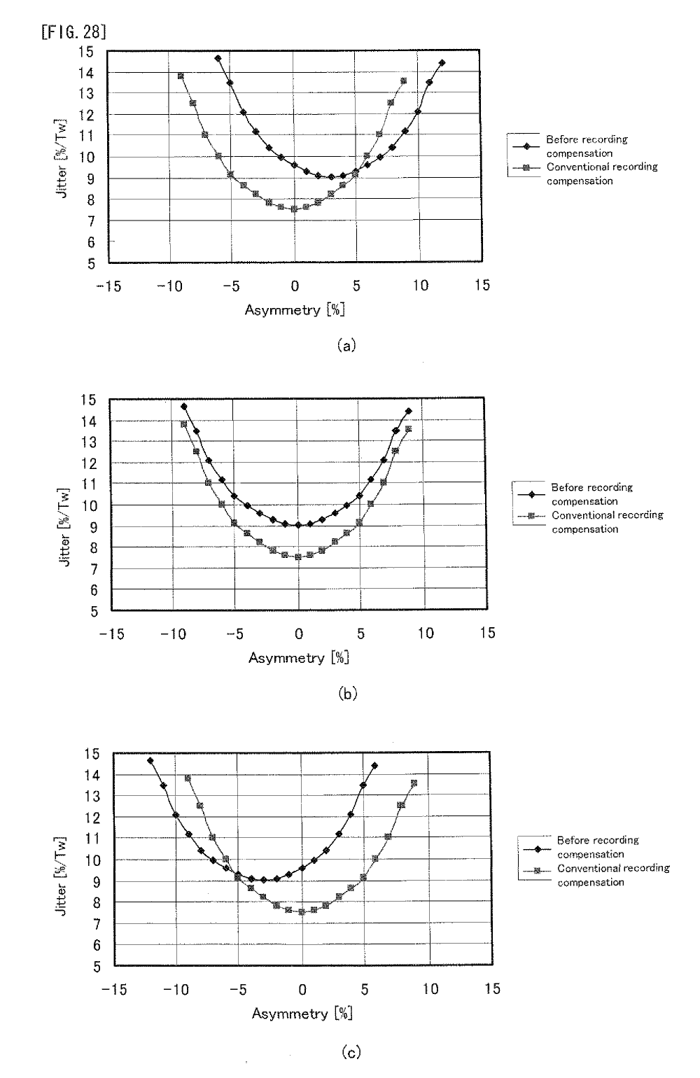

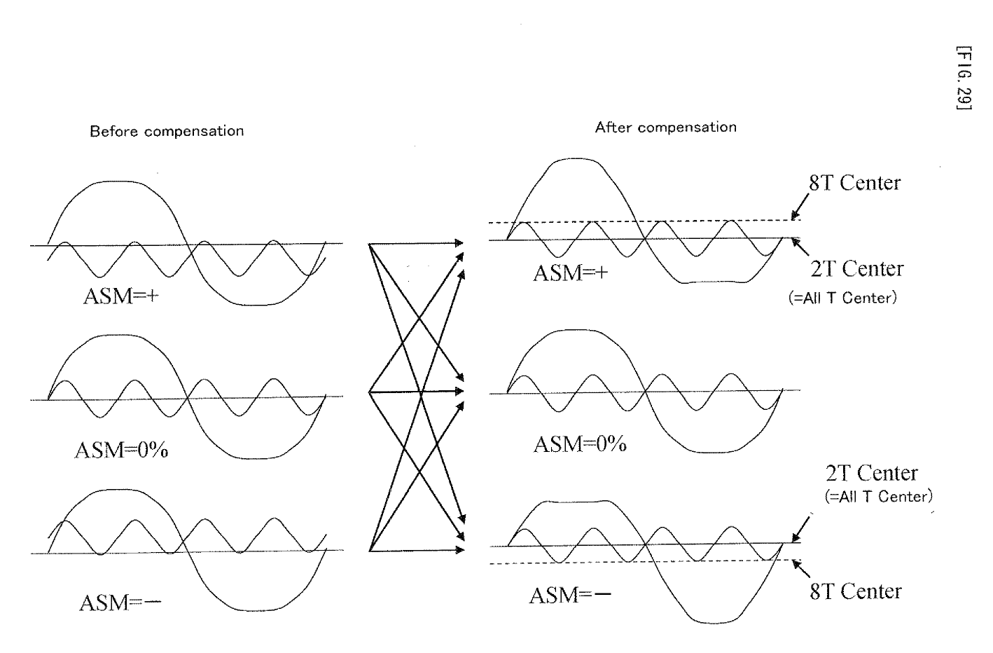

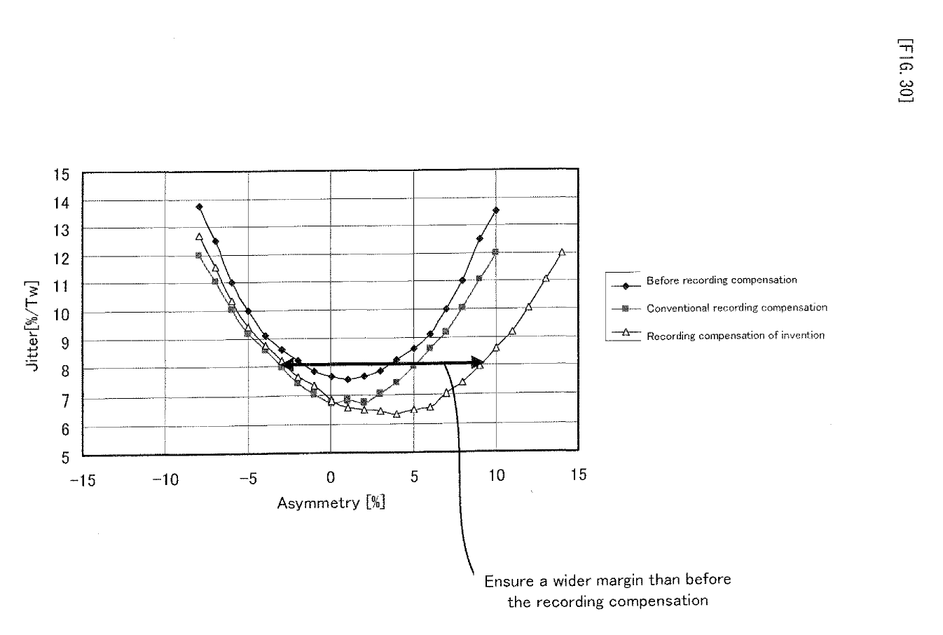

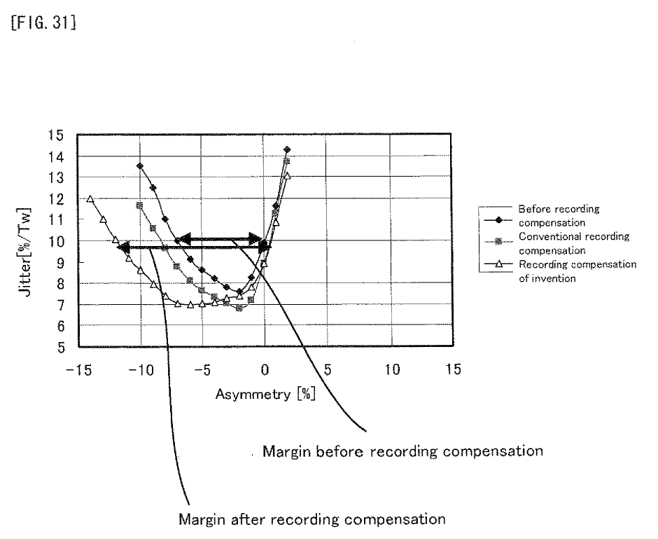

Next, with reference to FIG. 25 to FIG. 31, a first operation example of the information recording apparatus 3 in the third example will be explained. FIG. 25 is a flowchart conceptually showing a flow of operations in the first example operation of the information recording apparatus 3 in the third example. FIG. 26 is a graph conceptually showing the states of the shift jitter components in the respective data patterns and the shift jitter component as a whole before the recording compensation and the states of the shift jitter components in the respective data patterns and the shift jitter component as a whole after the recording compensation, in association with the asymmetry. FIG. 27 are graphs conceptually showing a relation between the asymmetry and the jitter before and after the recording compensation. FIG. 28 are graphs conceptually showing a relation between the asymmetry and the jitter before and after the recording compensation in a comparative example. FIG. 29 is a waveform diagram conceptually showing a relation between the read signal and the asymmetry before and after the recording compensation. FIG. 30 is a graph conceptually showing a relation between the asymmetry and the jitter before and after the recording compensation. FIG. 31 is a graph conceptually showing a relation between the asymmetry and the jitter before and after the recording compensation.

As shown in FIG. 25, firstly, from disc information recorded on the optical disc 100, recording pulse width information, recording power information (i.e. information about the amplitude of a recording pulse), and target asymmetry information are obtained (step S301). The recording pulse width information and the recording power information obtained are used as a basic pulse width and a basic power in the recording compensation operation. Moreover, the target asymmetry information is used as the aforementioned target asymmetry. It is obvious that any asymmetry other than the asymmetry indicated by the target asymmetry information may be used as the target asymmetry.

Then, as in the first operation example of the information recording apparatus 1 in the first example described above, the recording compensation operation (i.e. the operation in the step S101 to the step S103) is performed.

Moreover, particularly in the recording compensation operation in the third example, offset OFS is added to the read signal before the recording compensation operation in the step S103 (step S303). The addition of the offset OFS is performed by the reference level detection circuit 24, as described above.

Then, if the recording compensation operation is ended, it is judged whether or not a recording property is good (step S302). Here, for example, the judgment is performed on the basis of whether or not the asymmetry of the read signal is substantially the same as the target asymmetry or includes only an error of several % (e.g. 2.5%) of the target asymmetry. If the asymmetry of the read signal is substantially the same as the target asymmetry or includes only an error of several % of the target asymmetry, it is judged that the recording property is good. On the other hand, if the asymmetry of the read signal includes an error of several % or more in comparison to the target asymmetry, it is judged that the recording property is not good.

As a result of the judgment in the step S302, if it is judged that the recording property is not good (the step S302: No), the offset OFS corresponding to the difference between the target asymmetry and the asymmetry detected from the read signal in the step S303 is added, and the recording compensation operation in the step S101 to the step S103 is performed again.

On the other hand, as a result of the Judgment in the step S302, if it is judged that the recording property is good (the step S302: Yes), the operation is ended.

By this, as shown in FIG. 26, the asymmetry of the read signal after the recording compensation can be set to a desired value. For example, in an example shown on the upper side of FIG. 26, the asymmetry of the read signal after the recording compensation is set to −5%. In the same manner for example, in an example shown in the middle of FIG. 26, the asymmetry of the read signal after the recording compensation is set to 0%. In the same manner, for example, in an example shown on the lower side of FIG. 26, the asymmetry of the read signal after the recording compensation is set to 5%.

More specifically, as shown in FIG. 27(a), even if the jitter is minimal when the asymmetry of the read signal before the recording compensation is 0%, it is possible to set the asymmetry to +5%, 0%, or −5% while the jitter of the read signal after the recording compensation is minimal, by setting the target asymmetry to +5%, 0%, or −5%.

In the same manner, as shown in FIG. 27(b), even if the jitter is minimal when the asymmetry of the read signal before the recording compensation is 5%, it is possible to set the asymmetry to +5%, 0%, or −5% while the jitter of the read signal after the recording compensation is minimal, by setting the target asymmetry to +5%, 0%, or −5%.

In the same manner, as shown in FIG. 27(c), even if the jitter is minimal when the asymmetry of the read signal before the recording compensation is −5%, it is possible to set the asymmetry to +5%, 0%, or −5% while the jitter of the read signal after the recording compensation is minimal, by setting the target asymmetry to +5%, 0%, or −5%.

Unlike the information recording apparatus 3 in the third example, if the recording compensation operation is performed by an information recording apparatus in a comparative example which is not provided with the reference level detection device 24, as shown in FIG. 28(a), the asymmetry when the jitter of the read signal after the recording compensation is minimal is uniformly 0% even if the asymmetry of the read signal before the recording compensation is 2.5%. In the same manner, if the recording compensation operation is performed by the information recording apparatus in the comparative example, as shown in FIG. 28(b), the asymmetry when the jitter of the read signal after the recording compensation is minimal is uniformly 0% even if the asymmetry of the read signal before the recording compensation is 0%. In the same manner, if the recording compensation operation is performed by the information recording apparatus in the comparative example, as shown in FIG. 28(c), the asymmetry when the jitter of the read signal after the recording compensation is minimal is uniformly 0% even if the asymmetry of the read signal before the recording compensation is −2.5%. In other words, if the recording compensation operation is performed by the information recording apparatus in the comparative example which is not provided with the reference level detection device 24, the asymmetry when the jitter of the read signal after the recording compensation is minimal is uniformly 0%.

According to the third example, however, as shown in FIG. 29, in any value of the asymmetry of the read signal before the recording compensation, it is possible to set the asymmetry when the jitter after the recording compensation is minimal to the desired value, by setting the target asymmetry.

Moreover, the asymmetry may be adjusted by a recording power. By setting the target asymmetry and the asymmetry determined by the recording power adjustment, it is possible to perform the recording compensation operation while maintaining the asymmetry determined by the recording power adjustment.

In addition, due to the same structure as that of the information recording apparatus 1 in the first example, it is possible to preferably perform the recording compensation operation, regardless of the state of the asymmetry in the read signal before the recording compensation. In other words, the jitter can be reduced.

Therefore, it is possible to perform the recording compensation operation which realizes an optimum jitter value and the desired asymmetry. For example, if the optical disc 100 is a DVD, it is possible to perform the recording compensation operation which realizes the minimum jitter value and the asymmetry of +5%. In the same manner, if the optical disc 100 is a Blu-ray Disc, it is possible to perform the recording compensation operation which realizes the minimum jitter value and the asymmetry of +2.5%.

By this, as shown in FIG. 30, according to the recording compensation operation in the comparative example, a margin of only approximately −2.5% to 5% is reserved as the asymmetry that provides the jitter of 8% or less, whereas according to the third example, a margin of approximately −2.5% to 9% can be reserved.

Moreover, since the asymmetry of the read signal after the recording compensation can be set to the desired value without depending on the asymmetry of the read signal before the recording compensation, it is possible to perform the good recording compensation operation even if the asymmetry varies depending on the individual difference of the optical disc 100 and the information recording apparatus 3.

Moreover, since such construction that the offset corresponding to the difference between the detected asymmetry and the target asymmetry (i.e. such construction that the desired asymmetry is obtained after the recording compensation by adding the offset to the asymmetry before the recording compensation) is adopted, it is possible to set the asymmetry to an arbitrary value even if the asymmetry before the recording compensation varies due to the recording compensation operation which is performed a plurality of times.

Moreover, since it is unnecessary to adjust the asymmetry by adjusting the recording power (i.e. the amplitude of the recording pulse), it is possible to simplify the operation of adjusting a recording condition, and it is also possible to reduce a time required for the operation of adjusting the recording condition.

Moreover, in the recording compensation operation in the comparative example, the asymmetry of the read signal after the recording compensation converges to 0%. Thus, an optical disc which is easily influenced by thermal interference has such a technical problem that the margin is hardly reserved as shown in the property shown by black marks in FIG. 31. According to the third example, however, the asymmetry can be set to the desired value in the recording compensation operation, so that it is also possible to receive such an effect that the relatively wide margin can be reserved, as shown in the property shown by white triangular marks in FIG. 31.

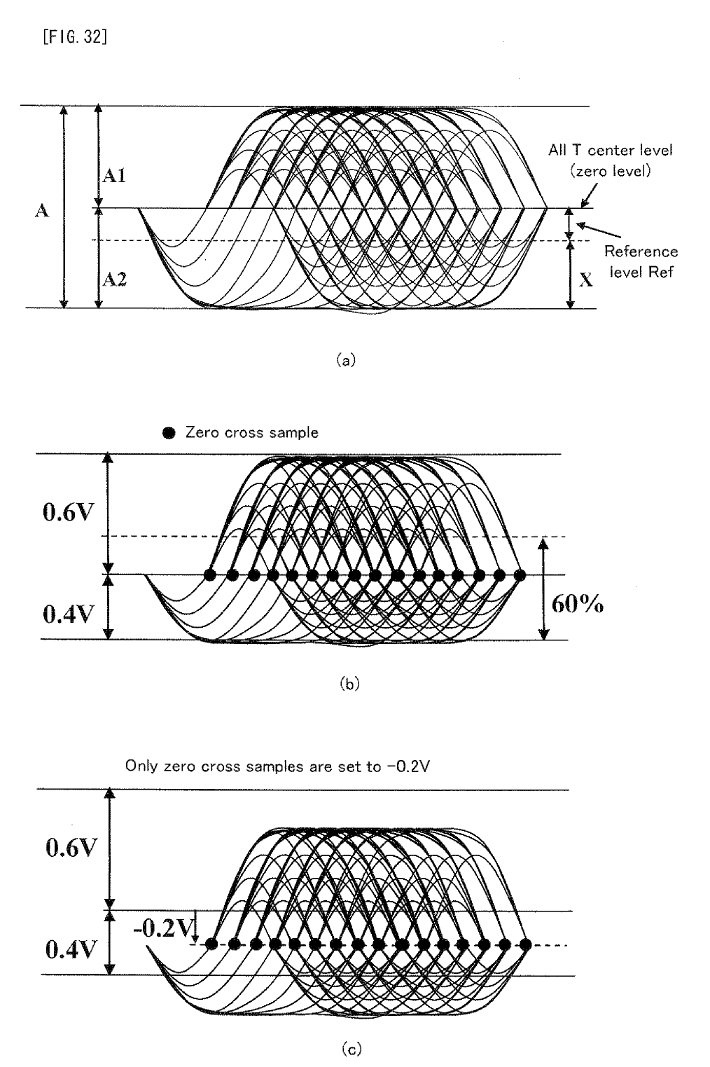

Incidentally, in the aforementioned explanation, the reference level detection device 24 for setting the target asymmetry is described; however, the reference level may be directly set. Such a structure will be explained with reference to FIG. 32. FIG. 32 are waveform diagrams conceptually showing an operation of setting the reference level on the waveform of the read signal.

As shown in FIG. 32(a), the reference level may be set at a rate X to the total amplitude (A=A1+A2) of the read signal. In other words, the reference level may be set such that the reference level=A2·(A1+A2)×X. In this case, the reference level detection device 24 detects the offset to be added to the read signal such that the reference level of the read signal is A2−(A1+A2)×X, and it outputs the offset to the adder 23.

Incidentally, as the rate X, it is preferable to use a value that can realize such a situation that the desired asymmetry value is obtained.

For example, it is assumed that the read signal shown in FIG. 32(b) is inputted to the reference level detection device 24. It is also assumed that the reference level is set to 60% of the total amplitude. In this case, the reference level is 0.4−(0.6+0.4)×0.6=−0.2V. Therefore, the reference level detection device 24 outputs the offset of −0.2V to the adder 23, and the adder 23 adds the offset of −0.2V to the read signal (i.e. the zero cross sample value). This is substantially the same as the operation of offsetting the reference level. As a result, the recording compensation operation is performed on the read signal to which the offset is added as shown in FIG. 32(c). Thus, as described above, it is possible to set the asymmetry of the read signal after the recording compensation to the desired value according to the added offset.

In this structure, it is possible to avoid such a disadvantage that the deviation increases between the asymmetry detected by a standard reproducing device and the asymmetry detected by the information recording apparatus 3 in the third example as the repetition frequency of the shortest data pattern becomes higher. Such an effect can be also received in a case where a recording speed is relatively high. Moreover, a highly accurate asymmetry detection circuit is no longer required, so that it is also possible to receive the effect that the cost of the information recording apparatus 3 can be reduced.

Incidentally, in the third example, the recording compensation operation is performed by using the high-frequency emphasized read sample value series RS_{H} outputted from the limit equalizer 15. However, from the viewpoint that the asymmetry of the read signal after the recording compensation can be set to the desired value, the recording compensation operation is not necessarily performed by using the high-frequency emphasized read sample value series RS_{H} outputted from the limit equalizer 15. In other words, even if the recording compensation operation is performed by using the read sample value series RS_{C} outputted from the pre-equalizer 14, obviously, it is possible to receive the effect that the asymmetry of the read signal after the recording compensation can be set to the desired value. Therefore, in the third example, the limit equalizer 15 is not necessarily provided.

(3-3) Second Operation Example

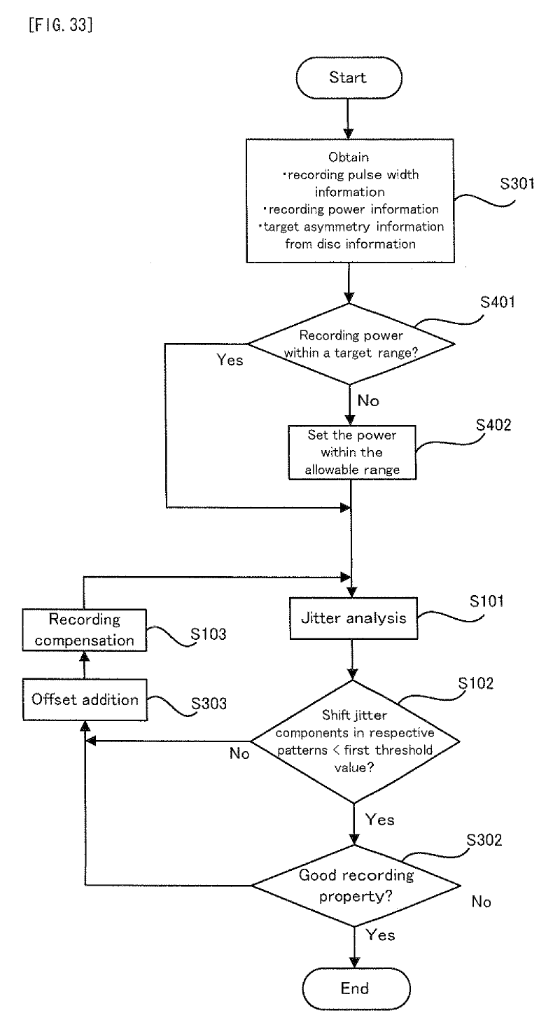

Next, with reference to FIG. 33, a second operation example of the information recording apparatus 3 in the third example will be explained. FIG. 33 is a flowchart conceptually showing a flow of operations in the second operation example of the information recording apparatus 3 in the third example. Incidentally, the same operation as in the aforementioned first operation example will carry the same step number, and the detailed explanation thereof will be omitted.

As shown in FIG. 33, firstly, from the disc information recorded on the optical disc 100, the recording pulse width information, the recording power information (i.e. the information about the amplitude of a recording pulse), and the target asymmetry information are obtained (the step S301).

Then, in the second operation example, it is judged whether or not the recording power is within an allowable range (step S401). In other words, it is judged whether or not there is consistency between the recording power information included in the disc information and the recording power used by the information recording apparatus 3.

As a result of the judgment in the step S401, if it is Judged that the recording power is within the allowable range (the step S401: Yes), the recording compensation operation (i.e. the operation in the step S101 to the step S103) is performed without change. On the other hand, as a result of the judgment in the step S401, if it is judged that the recording power is not within the allowable range (the step S401: No), the recording power is set to be within the allowable range before the recording compensation operation (i.e. the operation in the step S101 to the step S103 and the step S303) is performed.

Then, as in the first operation example, it is judged whether or not the recording property is good (the step S302). As a result of the judgment in the step S302, if it is judged that the recording property is not good (the step S302: No), the offset OFS corresponding to the difference between the target asymmetry and the asymmetry detected from the read signal in the step S303 is added, and the recording compensation operation in the step S101 to the step S103 is performed again. On the other hand, as a result of the judgment in the step S302, if it is judged that the recording property is good (the step S302: Yes), the operation is ended.

Even in the second operation example, it is possible to preferably receive the same various effects as those that can be received in the first operation example.

(3-4) Third Operation Example

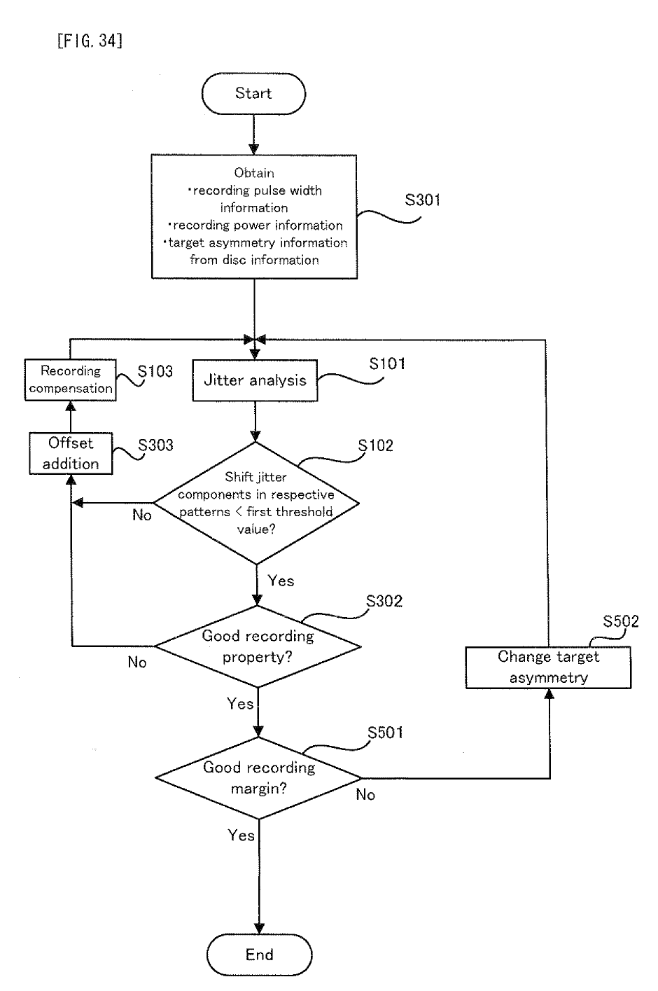

Next, with reference to FIG. 34, a third operation example of the information recording apparatus 3 in the third example will be explained. FIG. 34 is a flowchart conceptually showing a flow of operations in the third operation example of the information recording apparatus 3 in the third example. Incidentally, the same operation as in the aforementioned first operation example will carry the same step number, and the detailed explanation thereof will be omitted.

As shown in FIG. 34, firstly, from the disc information recorded on the optical disc 100, the recording pulse width information, the recording power information (i.e. the information about the amplitude of a recording pulse), and the target asymmetry information are obtained (the step S301).

Then, the recording compensation operation (i.e. the operation in the step S101 to the step S103 and the step S303) is performed. Then, as in the first operation example, it is judged whether or not the recording property is good (the step S302).

As a result of the judgment in the step S302, if it is judged that the recording property is not good (the step S302: No), the offset OFS corresponding to the difference between the target asymmetry and the asymmetry detected from the read signal in the step S303 is added, and the recording compensation operation in the step S101 to the step S103 is performed again.

On the other hand, as a result of the judgment in the step S302, if it is judged that the recording property is good (the step S302: Yes), then, it is judged whether or not a recording margin is good (step S501). Here, it is judged that the recording margin is good, for example, if a total jitter value in a range of the target asymmetry ±5% is less than or equal to a second threshold value.

As a result of the judgment in the step S501, if it is judged that the recording margin is not good (the step S501: No), the target asymmetry is changed (step S502) before the operational flow returns to the step S101, and then the operations after the step S101 are repeated. Here, as for the change in the target asymmetry, polarity to change may be determined depending on the total jitter value when the target asymmetry is −5% or +5%. For example, if the total jitter satisfies the following condition: (the total jitter when the target asymmetry is −5%)<(the total jitter when the target asymmetry is +5%), the target asymmetry is changed in a direction of reducing the asymmetry (or a minus direction). Moreover, if the total jitter has an inverse relation when the target asymmetry is ±5%, the target asymmetry is changed in a direction of increasing the asymmetry (or a plus direction).

The amount of change in the target asymmetry may be 1% or a half the asymmetry margin when the total jitter is the second threshold value.

On the other hand, as a result of the judgment in the step SS01, if it is judged that the recording margin is good (the step S501: Yes), the operation is ended.

Even in the third operation example, it is possible to preferably receive the same various effects as those that can be received in the first operation example.

### (4) Fourth Example

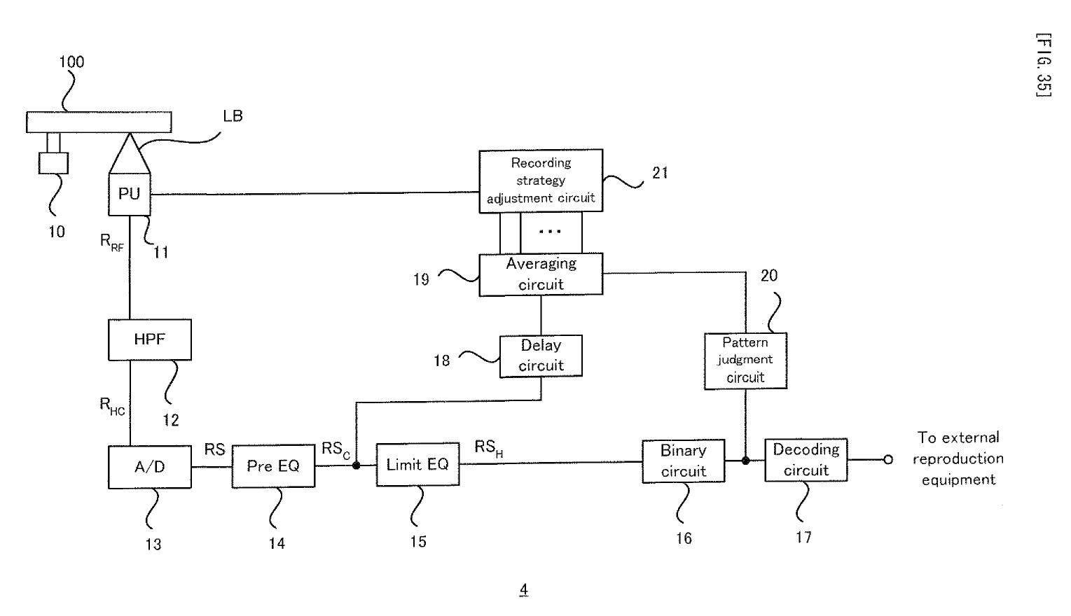

Next, with reference to FIG. 35, a fourth example of the information recording apparatus of the present invention will be explained. FIG. 35 is a block diagram conceptually showing the basic structure of the information recording apparatus in the fourth example.

As shown in FIG. 35, an information recording apparatus 4 in the fourth example is provided with a spindle motor 10, a pickup 11, a HPF 12, an A/D converter 13, a pre-equalizer 14, a limit equalizer 15, a binary circuit 16, a decoding circuit 17, a delay circuit 18, an averaging circuit 19, a pattern judgment circuit 20, and a recording strategy adjustment circuit 21, as in the information recording apparatus 1 in the first example.

In particular, the information recording apparatus 4 in the fourth example, the output of the previous step of the limit equalizer 15 (i.e. the output signal of the pre-equalizer 14) is inputted to the delay circuit 18. In other words, the output of the previous step of the limit equalizer 15 (i.e. the output signal of the pre-equalizer 14) is used to measure the jitter.

Even in this structure, the output of the limit equalizer 15 is used to judge the data pattern, so that it is possible to preferably receive the same effects as those in the first example.

### (5) Fifth Example

Next, a fifth example of the information recording apparatus of the present invention will be explained. An information recording apparatus 5 in the fifth example has the same structure as that of the information recording apparatus 1 in the first example, the information recording apparatus 3 in the third example, or the information recording apparatus 4 in the fourth example described above. In particular, the information recording apparatus 5 in the fifth example records the aforementioned result of the recording compensation operation (e.g. the recording condition such as the adjusted recording strategy, the resulting recording property, and the like) onto the optical disc 100. In this case, the result of the recording compensation operation is preferably recorded in association with identification information which can identify the information recording apparatus that has performed the recording compensation operation (e.g. a manufacturer code, a serial number of the information recording apparatus, or the like). More specifically, for example, the recording condition including a difference setting value between the optimum strategy and DI, the strategy set value of a laser driver, the jitter value, the β value, the asymmetry, the recording power, or the like may be recorded with the identification information, the target asymmetry information, or the like.

Incidentally, the result of the recording compensation operation may be recorded at each time of the recording operation, as occasion demands. Namely, it may be recorded when the recording operation is performed by a user, as occasion demands. Alternatively, it may be recorded in advance by using embossed pits, prewriting, or the like, in the manufacturing of the optical disc 100. In any cases, the aforementioned effects can be preferably received.

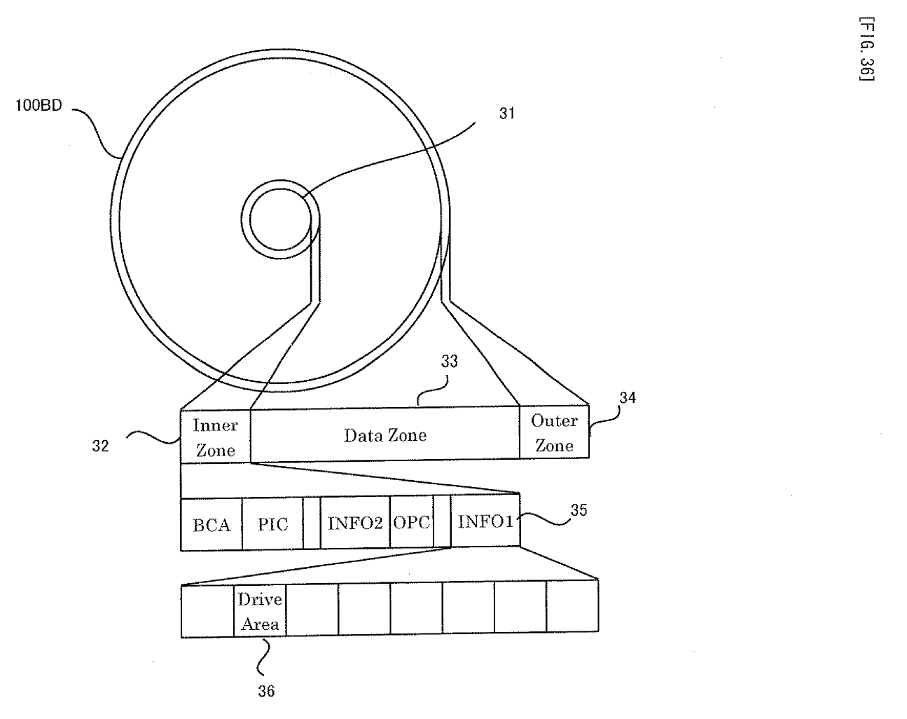

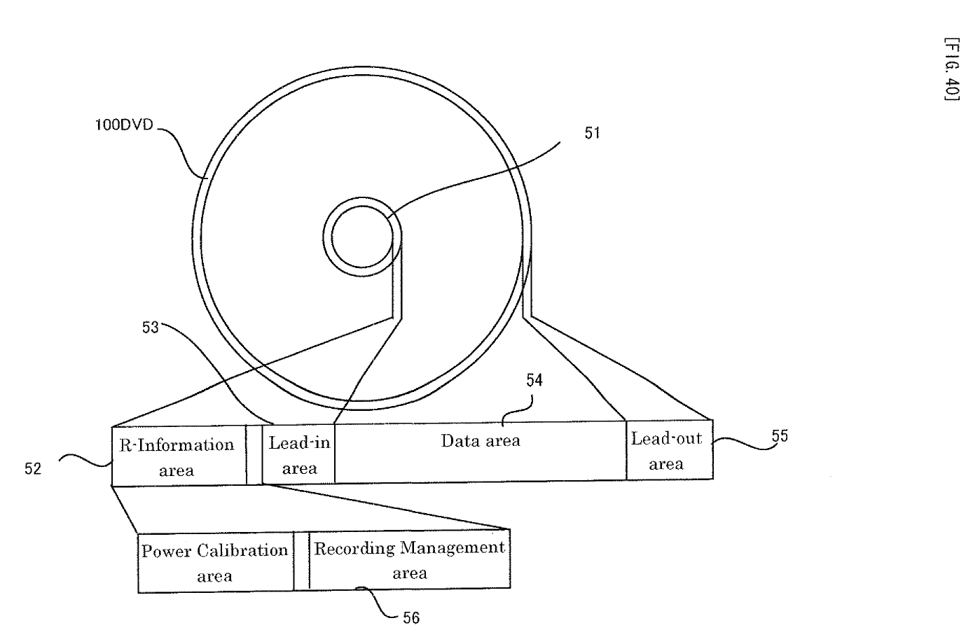

Hereinafter, with reference to FIG. 36 to FIG. 43, an explanation will be given on the data structure of the optical disc 100 on which the result of the recording compensation operation is recorded. FIG. 36 to FIG. 39 are data structure diagrams each showing one example of the data structure when recording a result of the recording compensation operation onto the Blu-ray Disc, which is one specific example of the optical disc. FIG. 40 to FIG. 43 are data structure diagrams each showing one example of the data structure when recording a result of the recording compensation operation onto a DVD, which is one specific example of the optical disc.

As shown in FIG. 36, a Blu-ray Disc as one specific example of the optical disc 100 (hereinafter referred to as an “optical disc 100BD”, as occasion demands) is provided with a center hole 31 as the center, an Inner zone 32, a Data zone 33, and an Outer zone 34.

The Inner zone 32 is provided with a BCA (Burst Cutting Area), a PIC area, an INFO2 area, an OPC (Optimum Power Control) area, and an INFO1 area 35.

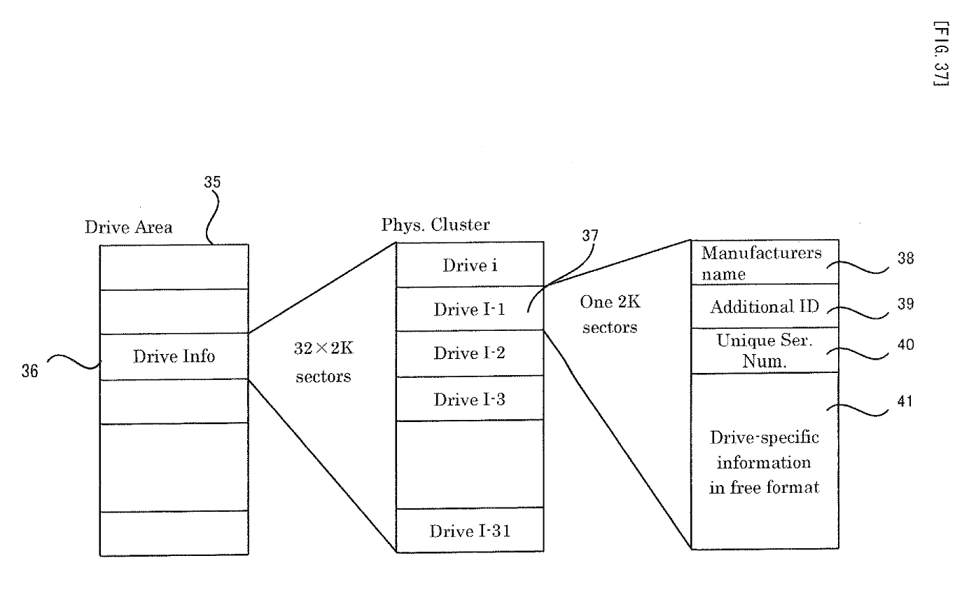

As shown in FIG. 37, the INFO1 area 35 is provided with a drive information (Drive Info) area 36. In the drive information area 36, 31 pieces of drive information (Drive Info-1 to Drive Info-31) 37 are recorded.

Each drive information 37 has a size of 1 sector (i.e. 2 KB) and includes a Manufactures name 38, an Additional ID 39, a Unique Serial Number 40, and a Drive-specific information 41 which can be described in free format.

In the fifth example, for example, the information indicating the result of the recording compensation operation may be recorded by using the drive-specific information 41, and the identification information which can identify the information recording apparatus that has performed the recording compensation operation may be recorded by using the Manufacturers name 38, the Additional ID 39, and the Unique Serial Number 40.

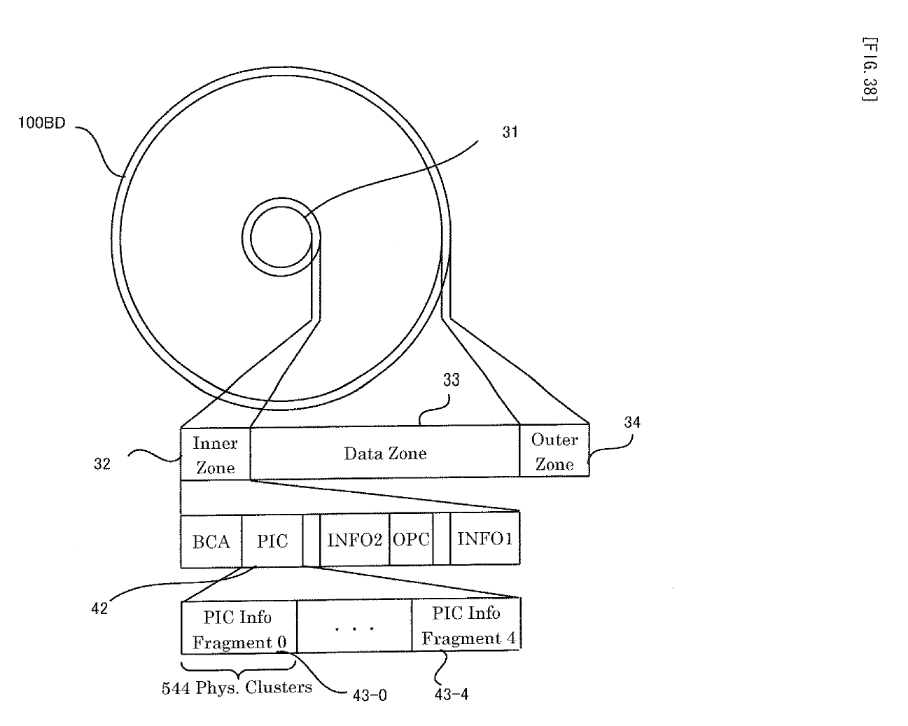

Alternatively, as shown in FIG. 38, the optical disc BD is provided with a PIC area 42. The PIC area 42 includes 5 PIC information fragments (i.e. PIC Info Fragment 0 to PIC Info Fragment 4) 43 each of which has a size of 544 clusters.

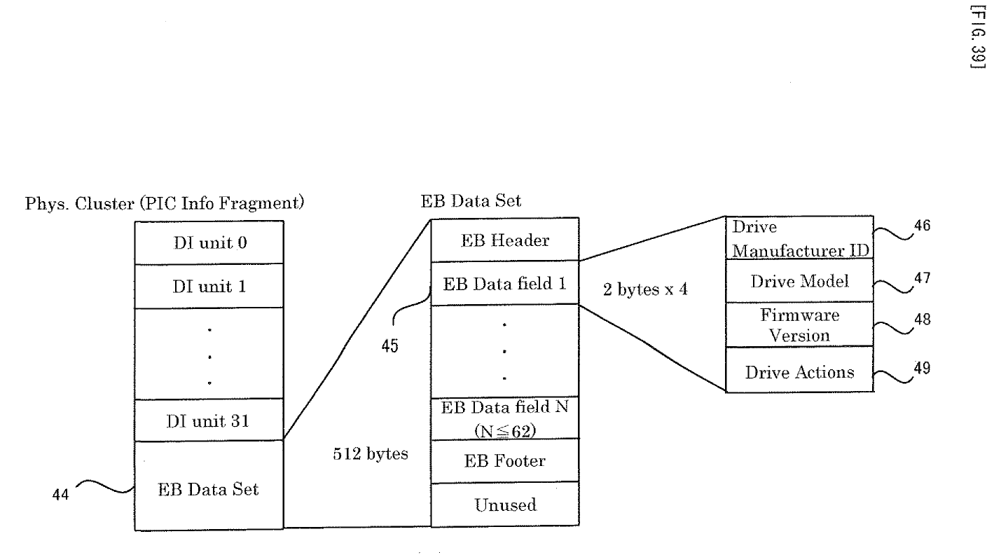

As shown in FIG. 39, each cluster in each PIC information fragment 43 includes 31 DI (Disc Information) units and an EB (Emergency Brake) data set 44 which has a size of 512 bytes.

The EB data set 44 includes an EB header, N EB data fields 45 each of which has a size of 8 bytes (wherein 1≦N≦62), an EB footer, and an unused area.

Each of the EB data fields 45 includes a drive manufacturer ID 46 which has a size of 2 bytes, a drive model 47 which has a size of 2 bytes, a firmware version 48 which has a size of 2 bytes, and drive action information 49 which has a size of 2 bytes.

In the fifth example, for example, the information indicating the result of the recording compensation operation may be recorded by using the drive action information 49, and the identification information which can identify the information recording apparatus that has performed the recording compensation operation may be recorded by using the drive manufacturer ID 46, the drive model 47, and the firmware version 48.

As shown in FIG. 40, a DVD as one specific example of the optical disc 100 (hereinafter referred to as an “optical disc 100DVD” as occasion demands) is provided with a center hole 51 as the center, an R-Information area 52, a Lead-in area 53, a Data area 54, and a Lead-out area 55.

The R-Information area 52 is provided with a PCA (Power Calibration Area) and a RMA (Recording Management Area) 56.

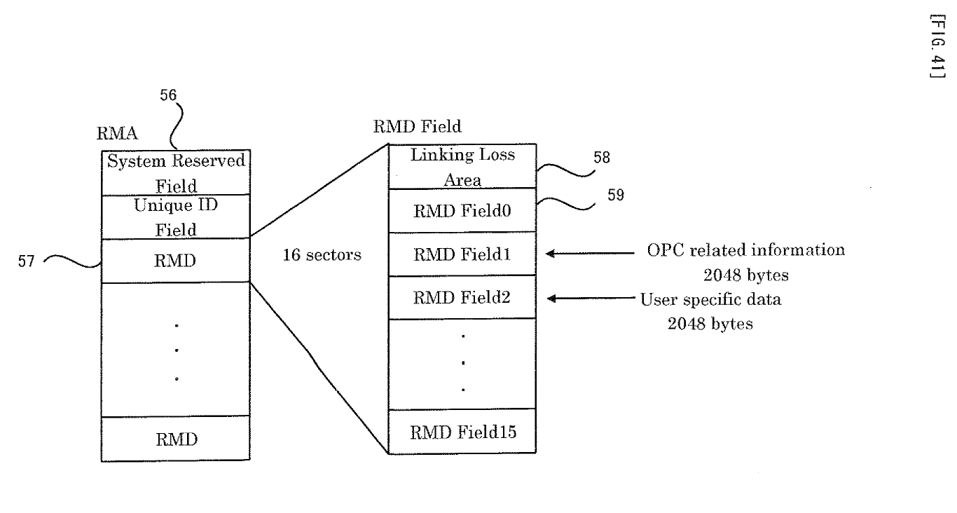

As shown in FIG. 41 the recording management area 56 includes a system reserved filed, a Unique ID field, and a plurality of RMD (Recording Management Data) 57 each of which has a size of 16 sectors.

Each of the RMD 57 includes a Linking Loss Area 58 and 16 RMD fields 59 each of which has a size of 2048 bytes. Of the 16 RMD fields 59, the RMD field 1 has OPC Related Information recorded. Moreover, of the 16 RMD fields 59, the RMD field 2 has User specific data recorded.

In the fifth example, for example, the OPC related information in the RMD field 1 and the user specific data in the RMD field 2 may be used to record the information indicating the result of the recording compensation operation and to record the identification information which can identify the information recording apparatus that has performed the recording compensation operation.

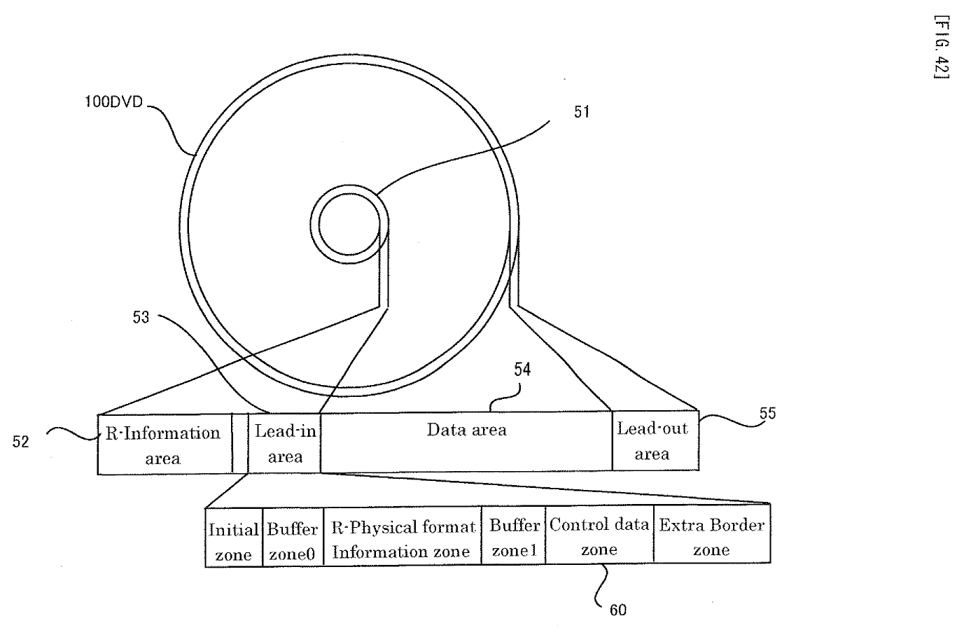

Moreover, as shown in FIG. 42, the Lead-in area 53 of the optical disc 100DVD is provided with an Initial zone, a Buffer zone 0, a R-physical format information zone, a Buffer zone 1, a Control data zone 60, and an Extra border zone.

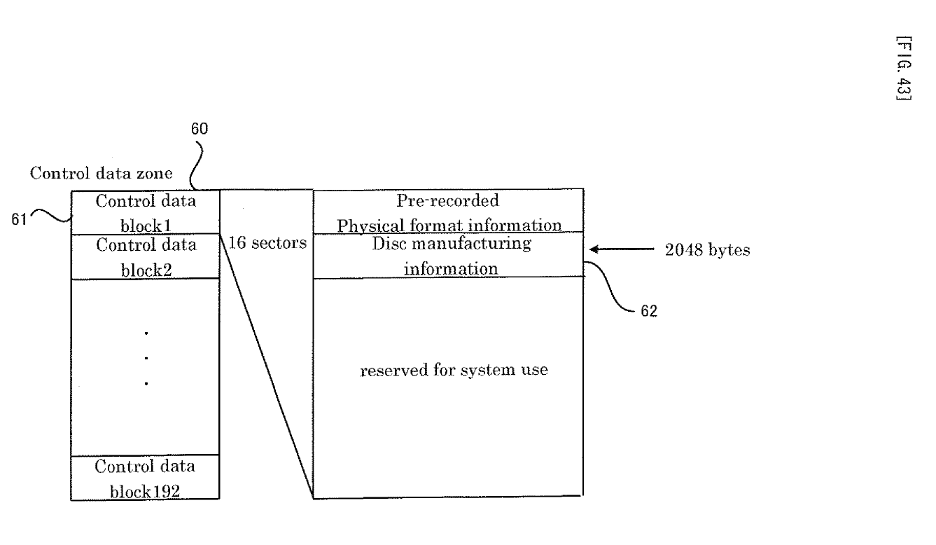

As shown in FIG. 43, the Control data zone 60 is provided with 192 Control data blocks 61 each of which has a size of 16 sectors. Each of the Control data blocks 61 includes Pre-recorded Physical format information, Disc manufacturing information 62 which has a size of 2048 bytes, and a reserved area (Reserved for system use).

In the fifth example, for example, the Disc manufacturing information 62 may be used to record the information indicating the result of the recording compensation operation and to record the identification information which can identify the information recording apparatus that has performed the recording compensation operation.

Incidentally, the examples shown in FIG. 36, FIG. 37, FIG. 40, and FIG. 41 are used in the case where the information indicating the result of the recording compensation operation and the identification information which can identify the information recording apparatus that has performed the recording compensation operation are recorded with the progression of the recording operation, as occasion demands. On the other hand, the examples shown in FIG. 38, FIG. 39, FIG. 42, and FIG. 43 are used in the case where the information indicating the result of the recording compensation operation and the identification information which can identify the information recording apparatus that has performed the recording compensation operation are recorded in advance in the manufacturing of the optical disc 100.

Of course, the examples shown in FIG. 36 to FIG. 43 are merely specific examples, and obviously, the information indicating the result of the recording compensation operation and the identification information which can identify the information recording apparatus that has performed the recording compensation operation may be recorded in another area.

As described above, by recording the information indicating the result of the recording compensation operation and the identification information which can identify the information recording apparatus that has performed the recording compensation operation onto the optical disc 100, it is possible to read the result of the recording compensation operation corresponding to the identification information about the information recording apparatus 5, from the optical disc 100, when the data pattern is recorded by the information recording apparatus 5. Thus, if the read result of the recording compensation operation is used to set the aforementioned recording condition, it is possible to receive the same various effects as those described above, in the recording operation performed on the optical disc 100 without the recording compensation operation.

Moreover, even if the result of the recording compensation operation corresponding to the identification information about the information recording apparatus 5 is not recorded on the optical disc 100, the same effects can be appropriately received by reading a result of the recording compensation operation corresponding to identification information close to the identification information about the information recording apparatus a (in other words, identification information about another information recording apparatus which has a similar property to that of the information recording apparatus 5) and by using the read result of the recording compensation operation to set the aforementioned recording condition. Alternatively, the same effects can be also appropriately received by performing the simple recording compensation operation on the basis of the result of the recording compensation operation corresponding to the identification information close to the identification information about the information recording apparatus 5.

Moreover, even if the information indicating the result of the recording compensation operation is not recorded on the optical disc 100 for the reason that that the optical disc 100 is blank or the like, if each of the information recording apparatuses in the aforementioned examples is used, the output of the limit equalizer 15 (i.e. the high-frequency emphasized read sample value series RS_{H}) is used for the pattern judgment. Thus, as described above, it is possible to preferably perform the recording compensation operation, regardless of the state of the asymmetry in the read signal before the recording compensation. Moreover, if the resulting recording condition is recorded on the optical disc 100 in association with the identification information about the information recording apparatus, it is possible to receive the same various effects as those described above, in the recording performed on the optical disc 100, without going to the trouble of performing the recording compensation operation.

In other words, according to the fifth example, without performing the recording compensation operation or with the recording compensation operation performed at least once, it is possible to receive the same various effects as those described above, in the recording performed on the optical disc 100, without going to the trouble of performing the recording compensation operation on the corresponding information recording apparatus. Therefore, it is possible to reduce the number of times that the recording compensation operation is performed, thereby saving an area required for the recording compensation operation.

The present invention is not limited to the aforementioned examples, but various changes may be made, if desired, without departing from the essence or spirit of the invention which can be read from the claims and the entire specification. An information recording apparatus and method, a computer program, and a recording medium, all of which involve such changes, are also intended to be within the technical scope of the present invention.

1. An information recording apparatus including:
a recording device for recording a data pattern onto a recording medium;
a reading device for reading the data pattern recorded on the recording medium, thereby obtaining a read signal;
an adding device for adding an offset signal to the read signal, thereby obtaining an offset-added signal;
a measuring device for measuring jitter of the offset-added signal;
a detecting device for detecting a data pattern of the read signal; and
an adjusting device for adjusting a recording condition of the recording device such that the jitter measured by the measuring device satisfies a desired condition, with reference to the data pattern detected by the detecting device.

2. The information recording apparatus according to claim 1, wherein the adding device adds the offset signal such that a reference level of the read signal is set to a level which indicates a predetermined rate of an amplitude of the read signal.

3. The information recording apparatus according to claim 1, wherein the adding device adds the offset signal such that asymmetry of the read signal is set to a desired value.

4. The information recording apparatus according to claim 1, wherein the adding device adds the offset signal corresponding to a difference between asymmetry of the read signal before the offset signal is added and the asymmetry desired to be realized by adding the offset signal.

5. The information recording apparatus according to claim 1, wherein
the measuring device measures, as the jitter, a shift jitter component caused by a state of the recorded data pattern from among the jitter, and
the adjusting device adjusts the recording condition such that the shift jitter component as the jitter satisfies the desired condition.

6. The information recording apparatus according to claim 5, wherein_the a in which the jitter satisfies the desired condition is a state in which the shift jitter component is less than or equal to a first predetermined value.

7. The information recording apparatus according to claim 5, wherein a state in which the jitter satisfies the desired condition is a state in which a ratio of a random jitter component, which is caused by a noise from among the jitter, to the jitter is greater than or equal to a second predetermined value.

8. The information recording apparatus according to claim 5, wherein_a state in which the jitter satisfies the desired condition is a state in which the shift jitter components in a plurality of respective data patterns with different run lengths are substantially the same to each other.

9. The information recording apparatus according to claim 5, wherein the measuring device measures, as the shift jitter component, an average value in each data pattern of sample values of the offset-added signal which is the closest to a zero level point.

10. The information recording apparatus according to claim 5, wherein the adjusting device preferentially adjusts the recording condition in recording the data pattern having the relatively large shift jitter component out of a plurality of type of the data patterns with different run lengths.

11. The information recording apparatus according to claim 1, wherein
the recording device applies a laser beam, thereby recording the data pattern, and
the recording condition is at least one of an amplitude and a pulse width of the laser beam or a driving pulse for driving the laser beam.

12. The information recording apparatus according to claim 1, further including an amplitude limit filtering device for limiting an amplitude level of the read signal by using a predetermined amplitude limit value, thereby obtaining an amplitude limit signal and for performing a high-frequency emphasis filtering process on the amplitude limit signal, thereby obtaining an equalization-corrected signal,
the adding device adding the offset signal to the equalization-corrected signal, thereby obtaining the offset-added signal,
the detecting device detecting the data pattern of the equalization-corrected signal.

13. The information recording apparatus according to claim 1, wherein the recording device records the recording condition adjusted by the adjusting device.

14. An information recording method in an information recording apparatus including a recording device for recording a data pattern onto a recording medium,
the information recording method including:
a reading process of reading the data pattern recorded on the recording medium, thereby obtaining a read signal;
an adding process of adding an offset signal to the read signal, thereby obtaining an offset-added signal;
a measuring process of measuring jitter of the offset-added signal;
a detecting process of detecting a data pattern of the read signal; and
an adjusting process of adjusting a recording condition of the recording device such that the jitter measured in the measuring process satisfies a desired condition, with reference to the data pattern detected in the detecting process.

15. A computer-readable recording medium recording thereon a computer program for recording control and for controlling a computer provided in an information recording apparatus including: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device,
the computer program making the computer function as at least one portion of the recording device, the reading device, the adding device, the measuring device, the detecting device, and the adjusting device.

16. A recording medium including a recording condition recording area to record therein a recording condition adjusted by an information recording apparatus including: a recording device for recording a data pattern onto a recording medium; a reading device for reading the data pattern recorded on the recording medium, thereby obtaining a read signal; an adding device for adding an offset signal to the read signal, thereby obtaining an offset-added signal; a measuring device for measuring jitter of the offset-added signal; a detecting device for detecting a data pattern of the read signal; and an adjusting device for adjusting a recording condition of the recording device such that the jitter measured by the measuring device satisfies a desired condition, with reference to the data pattern detected by the detecting device.
